(19) United States
(12) Patent Application Publication
(10) Pub. No.: US 2023/0420174 A1
(43) Pub. Date: Dec. 28, 2023

(54) MAGNETIC CORE AND MAGNETIC DEVICE

(71) Applicant: TDK CORPORATION, Tokyo (JP)

(72) Inventors: Kazuhiro YOSHIDOME, Tokyo (JP); Satoko MORI, Tokyo (JP); Hiroyuki MATSUMOTO, Tokyo (JP)

(73) Assignee: TDK CORPORATION, Tokyo (JP)

(21) Appl. No.: 18/339,765

(22) Filed: Jun. 22, 2023

(30) Foreign Application Priority Data
Jun. 22, 2022 (JP) 2022-100545

(51) Int. Cl. H01F 27/255; B22F 1/052; B22F 1/08; B22F 1/16; B22F 9/08; B22F 3/24; B22F 3/02

(52) U.S. Cl. CPC H01F 27/255; B22F 1/052; B22F 1/08; B22F 1/16; B22F 9/082; B22F 3/24; B22F 3/02; B22F 2304/10; B22F 2301/35; B22F 2009/0824; B22F 2998/10; B22F 2003/248

(57) ABSTRACT

A magnetic core includes metal magnetic particles. A total area percentage of the metal magnetic particles in a cross section of the magnetic core is 75% or more and 90% or less. The metal magnetic particles include first particles whose Haywood diameters in the cross section of the magnetic core are 3 μm or more and second particles whose Haywood diameters in the cross section of the magnetic core are less than 3 μm. The second particles include two or more types of small particles with different compositions of films existing on their particle surfaces.

### TECHNICAL FIELD

The present disclosure relates to a magnetic core including a metal magnetic powder and a magnetic device including the magnetic core.

### BACKGROUND

Magnetic devices, such as inductors, transformers, and choke coils, including a magnetic core (dust core) containing a metal magnetic powder and a resin are known. Various attempts are made to improve the DC bias characteristics of such magnetic devices.

For example, Patent Document 1 discloses a dust core using two types of metal magnetic powders with different particle sizes and aspect ratios. According to Patent Document 1, a coarse powder and a fine powder are mixed, which improves the relative density of the dust core and makes it possible to improve the DC bias characteristics.

The demand for miniaturization, more efficient, and energy-saving magnetic devices is now stronger, and there is a need to further improve the DC bias characteristics over conventional magnetic devices like the one of Patent Document 1.

Patent Document 1: JP 2016012630 (A)

### BRIEF SUMMARY

The present disclosure has been achieved under such circumstances. It is an object of the disclosure to provide a magnetic core exhibiting the DC bias characteristics superior to conventional ones and a magnetic device including the magnetic core.

To achieve the above object, a magnetic core according to the present disclosure comprises metal magnetic particles, wherein
a total area percentage of the metal magnetic particles in a cross section of the magnetic core is 75% or more and 90% or less,
the metal magnetic particles include:
   first particles whose Haywood diameters in the cross section of the magnetic core are 3 μm or more; and
   second particles whose Haywood diameters in the cross section of the magnetic core are less than 3 μm, and
the second particles comprise two or more types of small particles with different compositions of films existing on their particle surfaces.

In the magnetic core having the above-mentioned features, the DC bias characteristics can be improved more than before.

Preferably, A1>A2 is satisfied, in which A1 is a total area percentage of the first particles in the cross section of the magnetic core, and A2 is a total area percentage of the second particles in the cross section of the magnetic core.

Preferably, the first particles comprise large particles having an average circularity of 0.90 or more.

The magnetic core according to the present disclosure can be applied to various magnetic devices, such as inductors, transformers, and choke coils.

### BRIEF DESCRIPTION OF THE DRAWING(S)

FIG. 1 is a schematic view illustrating a cross section of a magnetic core according to an embodiment of the present disclosure;

FIG. 2A is a graph showing an example of a particle size distribution of a metal magnetic powder;

FIG. 2B is a graph showing an example of a particle size distribution of a metal magnetic powder;

FIG. 2C is a graph showing an example of a particle size distribution of a metal magnetic powder;

FIG. 3 is a schematic view illustrating an enlarged cross section of the magnetic core shown in FIG. 1;

FIG. 4 is a cross-sectional schematic view illustrating an example of a powder processing apparatus used for forming insulating films on small particles; and

FIG. 5 is a cross-sectional view illustrating an example of a magnetic device according to the present disclosure.

### DETAILED DESCRIPTION

Hereinafter, the present disclosure is described in detail based on an embodiment shown in the figures.

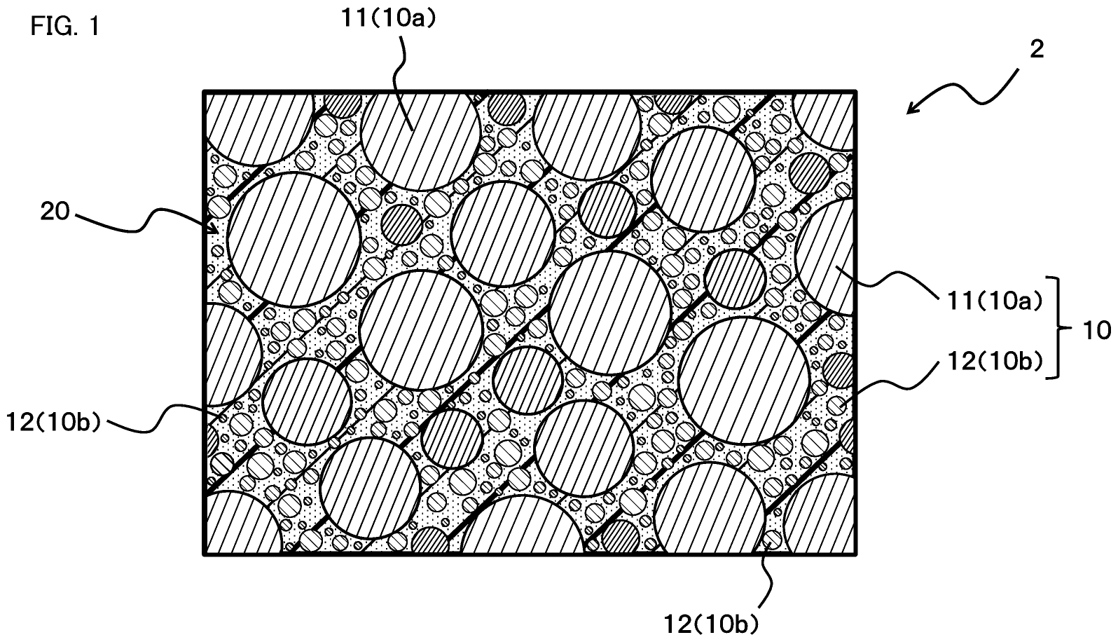

A magnetic core 2 according to the present embodiment has a predetermined shape, but its outer dimensions and shape are not limited. As shown in the cross-sectional view of FIG. 1, the magnetic core 2 includes at least metal magnetic particles 10 and a resin 20, and the metal magnetic particles 10 are bound together via the resin 20. Then, the magnetic core 2 has a predetermined shape.

A total area percentage A0 of the metal magnetic particles 10 in a cross section of the magnetic core 2 is 75% or more and 90% or less. The total area percentage A0 of the metal magnetic particles 10 corresponds to a packing rate of the metal magnetic particles 10 in the magnetic core 2 and is calculated by analyzing a cross section of the magnetic core 2 using an electron microscope, such as a scanning electron microscope (SEM) and a scanning transmission electron microscope (STEM). For example, any cross section of the magnetic core 2 is divided into a plurality of continuous fields of view and observed, and areas of the metal magnetic particles 10 contained in each field of view are measured. Then, a total area percentage A0 (%) of the metal magnetic particles 10 is calculated by dividing a total area of the metal magnetic particles 10 by a total area of the observed fields of view. In this cross-sectional analysis, the total area of the fields of view is preferably at least 1,000,000 μm². In the cross-sectional analysis, if a cut surface of the observation sample (a surface obtained by cutting and polishing the magnetic core 2) is less than the above-mentioned total area of the fields of view, the total area of the fields of view may be increased to 1,000,000 μm² or more by analyzing a predetermined cut surface, thereafter subjecting this cut surface to polishing or the like once again by 100 μm or more, and performing a cross-sectional analysis once again.

The metal magnetic particles 10 contained in the magnetic core 2 can be divided into a plurality of particle groups based on their Heywood diameters. Here, the “Heywood diameter” in the present embodiment is a circle equivalent diameter of each of the metal magnetic particles 10 observed in a cross section of the magnetic core 2. Specifically, the Heywood diameter of each of the metal magnetic particles 10 is represented by (4S/π)^{1/2}, where S is an area of each of the metal magnetic particles 10 in a cross section of the magnetic core 2.

For example, when the metal magnetic particles 10 are roughly divided, the metal magnetic particles 10 can be divided into first particles 10a and second particles 10b. The first particles 10a are the metal magnetic particles 10 with Heywood diameters of 3 μm or more, and the second particles 10b are the metal magnetic particles 10 with Heywood diameters of less than 3 μm.

In the magnetic core 2, the content rate of the first particles 10a is preferably higher than the content rate of the second particles 10b. That is, in a cross section of the magnetic core 2, A1>A2 is preferably satisfied, where A2 is a total area percentage of the first particles 10a, and A2 is a total area percentage of the second particles 10b. When the content rate of the first particles 10a is higher than that of the second particles 10b, the magnetic permeability of the magnetic core 2 can be improved. Note that, the sum of A1 and A2 is a total area percentage A0 of the metal magnetic particles 10 (A1+A2=A0), and A1 and A2 are measured in the same manner as A0.

The metal magnetic particles 10 can be divided in more detail based on their particle size distribution. The particle size distribution of the metal magnetic particles 10 is determined by measuring Heywood diameters of at least 1,000 metal magnetic particles 10 in any cross section of the magnetic core 2. In the magnetic core 2, the particle size distribution of the metal magnetic particles 10 has at least two peaks. That is, the metal magnetic particles 10 include two or more particle groups with different average particle sizes.

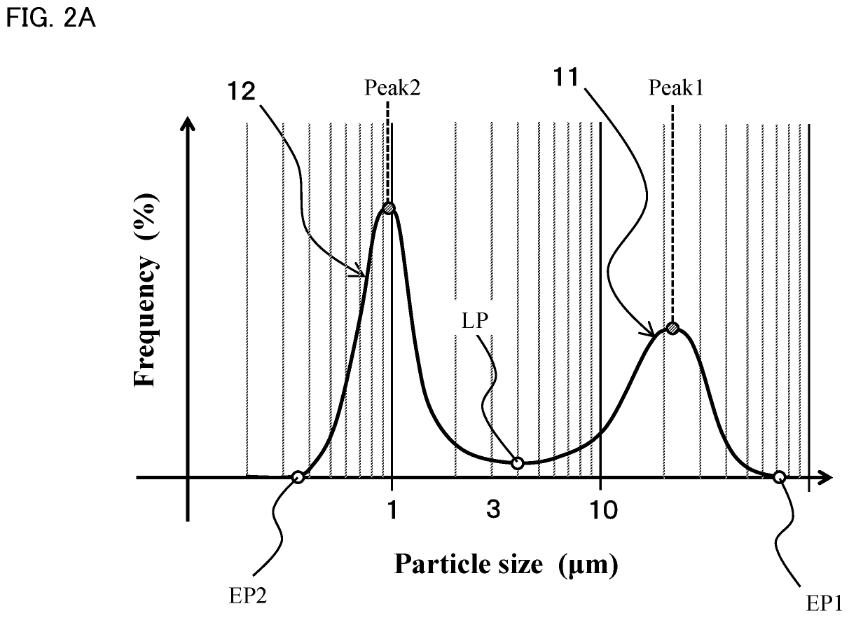

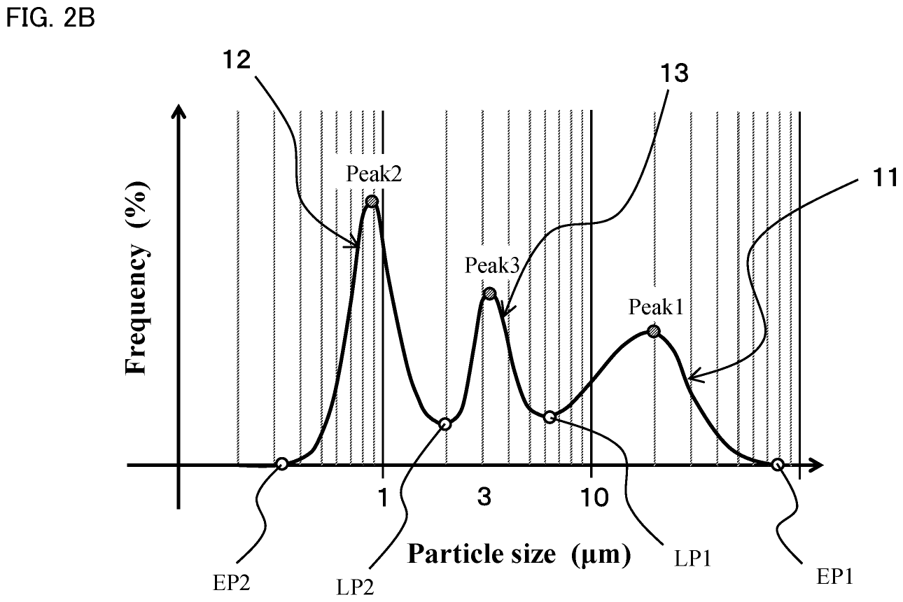

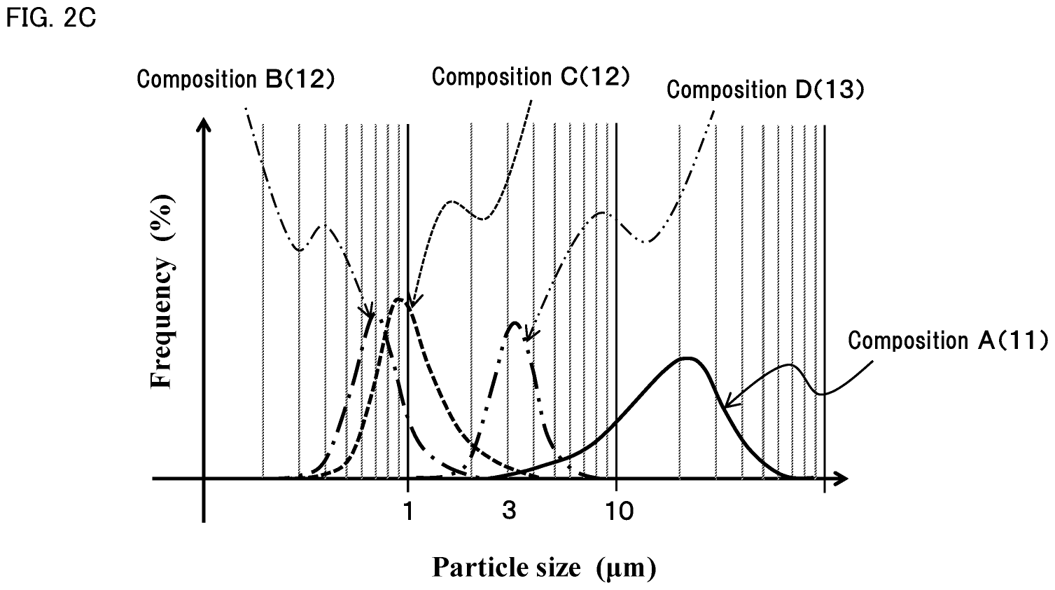

For example, the graphs exemplified in FIG. 2A to FIG. 2C are particle size distributions of the metal magnetic particles 10. In each of the graphs of FIG. 2A to FIG. 2C, the vertical axis is an area-based frequency (%), and the horizontal axis is a logarithmic axis showing a particle size (μm) in terms of Haywood diameter. The particle size distributions shown in FIG. 2A to FIG. 2C are examples, and the particle size distributions of the metal magnetic particles 10 are not limited to those shown in FIG. 2A to FIG. 2C.

When the metal magnetic particles 10 consist of two particle groups (large particles and small particles) with different average particle sizes, as shown in FIG. 2A, the particle size distribution of the metal magnetic particles 10 has two peaks. When the metal magnetic particles 10 consist of three particle groups (large particles, medium particles, and small particles) with different average particle sizes, as shown in FIG. 2B, the particle size distribution of the metal magnetic particles 10 has three peaks. As shown in FIG. 2A and FIG. 2B, when the particle size distribution of the metal magnetic particles 10 is represented by a continuous distribution curve, the particle group belonging to the peak located on the largest diameter side (the peak located on the rightmost side of the horizontal axis) and having a D20 of 3 μm or more is defined as large particles 11, and the particle group belonging to the peak located on the smallest diameter side (the peak located on the leftmost side of the horizontal axis) and having a D80 of less than 3 μm is defined as small particles 12. Moreover, particles other than the large particles 11 and the small particles 12 are defined as medium particles 13.

Here, the “particle group belonging to the peak located on the largest diameter side” means a particle group contained in the range from the foot (rightmost end) of the distribution curve to the local minimum point via the peak top when tracing the distribution curve from the large diameter side (right side of the graph). That is, in the particle size distribution shown in FIG. 2A, the particle group contained in the range from EP1 to LP via Peak 1 corresponds to the “particle group belonging to the peak located on the largest diameter side”. In the particle size distribution shown in FIG. 2B, the particle group contained in the range from EP1 to LP1 via Peak 1 corresponds to the “particle group belonging to the peak located on the largest diameter side”.

D20 means a Heywood diameter at which the area-based cumulative frequency is 20%. In the particle size distributions of FIG. 2A and FIG. 2B, D20 of the particle group belonging to Peak 1 is 3 μm or more, and this particle group belonging to Peak 1 is the large particles 11.

The “particle group belonging to the peak located on the smallest diameter side” means a particle group contained in the range from the foot (leftmost end) of the distribution curve to the local minimum point via the peak top when tracing the distribution curve from the small diameter side (left side of the graph). That is, in the particle size distribution shown in FIG. 2A, the particle group contained in the range from EP2 to LP via Peak 2 corresponds to the “particle group belonging to the peak located on the smallest diameter side”. In the particle size distribution shown in FIG. 2B, the particle group contained in the range from EP2 to LP2 via Peak 2 corresponds to the “particle group belonging to the peak located on the smallest diameter side”.

D80 means a Heywood diameter at which the area-based cumulative frequency is 80%. In the particle size distributions of FIG. 2A and FIG. 2B, D80 of the particle group belonging to Peak 2 is less than 3 μm, and this particle group belonging to Peak 2 is the small particles 12.

In the particle size distribution of FIG. 2B, the particle group from LP1 to LP2 via Peak 3 is a particle group belonging to Peak 3. In the particle group belonging to Peak 3, D20 is less than 3 μm, and D80 is 3 μm or more. That is, the particle group belonging to Peak 3 is the medium particles 13 corresponding to neither the large particles 11 nor the small particles 12.

As shown in FIG. 2A and FIG. 2B, the metal magnetic particles 10 of the magnetic core 2 include the large particles 11 and the small particles 12 and may also include other particle groups such as the medium particles 13. The large particles 11 may include two or more particle groups with different particle compositions, and the small particles 12 may also include two or more particle groups with different particle compositions. In addition, the large particles 11 and the small particles 12 may have the same composition or may have different compositions.

Note that, “different particle compositions” means that the types of constituent elements contained in the particle body are different from each other, or that the content rates of constituent elements are different from each other even if the types of constituent elements are the same. A constituent element means an element contained in the particle body in an amount of 1 at % or more. That is, among elements contained in the particle body, the elements other than impurity elements are referred to as constituent elements.

When the particle groups, such as the large particles 11 and the small particles 12, have different compositions, that is, when the metal magnetic particles 10 include two or more types of particle groups with different particle compositions, the metal magnetic particles 10 may be divided using composition analysis and particle size analysis in combination. Specifically, when a cross section of the magnetic core 2 is observed with an electron microscope, a composition of each of the metal magnetic particles 10 contained in the observation field is analyzed using an energy dispersive X-ray analyzer (EDX device) or an electron probe microanalyzer (EPMA), and the metal magnetic particles 10 are divided based on the composition. Then, a plurality of distribution curves is obtained by measuring Heywood diameters of the metal magnetic particles 10 belonging to each composition.

For example, when the metal magnetic particles 10 consist of four particle groups with different particle compositions, as shown in FIG. 2C, four distribution curves are obtained. In the particle size distributions of FIG. 2C, the distribution curve of the particle group having Composition A is indicated by a solid line, the distribution curve of the particle group having Composition B is indicated by a one-dot chain line, the distribution curve of the particle group having Composition C is indicated by a dotted line, and the distribution curve of the particle group having Composition D is indicated by a two-dot chain line.

As shown in FIG. 2C, when the particle size distribution of the metal magnetic particles 10 is represented by a plurality of distribution curves based on the compositions, a particle group having a D20 of 3 μm or more is defined as large particles 11, a particle group having a D80 of less than 3 μm is defined as small particles 12, and a particle group other than the large particles 11 and the small particles 12 is defined as medium particles 13. That is, in FIG. 2C, the particle group having Composition A is the large particles 11, the particle group having Composition B and the particle group having Composition C are the small particles 12, and the particle group having Composition D is the medium particles 13.

As described above, D20 of the large particles 11 is 3 μm or more, and each of the large particles 11 preferably has a Heywood diameter of 3 μm or more. The average value of the Heywood diameters (arithmetic mean diameter) of the large particles 11 is not limited and, for example, is preferably 5 μm or more and 40 μm or less and is more preferably 10 μm or more and 35 μm or less. D80 of the small particles 12 is less than 3 μm, and each of the small particles 12 preferably has a Heywood diameter of less than 3 μm. Moreover, the average value of the Heywood diameters (arithmetic mean diameter) of the small particles 12 is not limited and, for example, is preferably 2 μm or less and is more preferably 0.2 μm or more and less than 2 μm.

Preferably, AL is larger than AS (AL>AS), where AL is a total area percentage of the large particles 11 in a cross section of the magnetic core 2, and AS is a total area percentage of the small particles 12 in a cross section of the magnetic core 2. Specifically, the ratio of the total area of the large particles 11 to the total area of the metal magnetic particles 10 (AL/A0) is preferably more than 50% and 90% or less and is more preferably 60% or more and 82% or less. The ratio of the total area of the small particles 12 to the total area of the metal magnetic particles 10 (AS/A0) is preferably 8% or more and less than 50% and is more preferably 10% or more and 40% or less. When the magnetic core 2 includes the large particles 11 and the small particles 12 in the above-mentioned ratios, it is possible to more favorably achieve both high magnetic permeability and excellent DC bias characteristics. Note that, AL and AS mentioned above are measured in the same manner as A0.

When the metal magnetic particles 10 include the medium particles 13, the average value of the Heywood diameters (arithmetic mean diameter) of the middle particles 13 is not limited and, for example, is preferably 3 μm or more and 5 μm or less. Also, the ratio of the total area of the medium particles 13 to the total area of the metal magnetic particles 10 (AM/A0) is preferably 5% or more and 30% or less.

In the present embodiment, the methods shown in FIG. 2A to FIG. 2C are indicated as methods for dividing the metal magnetic particles 10 into the large particles 11 and the small particles 12, but it is preferable to employ the division method shown in FIG. 2A or FIG. 2B when the small particles 12 have the same particle composition as the large particles 11 or the medium particles 13, and it is preferable to employ the division method shown in FIG. 2C when the small particles 12 have a particle composition different from that of the large particles 11 and the medium particles 13.

Each of the metal magnetic particles 10 is comprised of a soft magnetic metal, and its composition is not limited. For example, the metal magnetic particles 10 can be pure iron, a crystalline alloy, a nanocrystalline alloy, or an amorphous alloy. The crystalline soft magnetic alloy includes a Fe—Ni based alloy, a Fe—Si based alloy, a Fe—Si—Cr based alloy, a Fe—Si—Al based alloy, a Fe—Si—Al—Ni based alloy, a Fe—Ni—Si—Co based alloy, a Fe—Co based alloy, a Fe—Co—V based alloy, a Fe—Co—Si based alloy, a Fe—Co—Si—Al based alloy, or the like. The nanocrystalline or amorphous soft magnetic alloy includes a Fe—Si—B based alloy, a Fe—Si—B—C based alloy, a Fe—Si—B—C—Cr based alloy, a Fe—Nb—B based alloy, a Fe—Nb—B—P based alloy, a Fe—Nb—B—Si based alloy, a Fe—Co—P—C based alloy, a Fe—Co—B based alloy, a Fe—Co—B—Si based alloy, a Fe—Si—B—Nb—Cu based alloy, a Fe—Si—B—Nb—P based alloy, a Fe—Co—B—P—Si based alloy, a Fe—Co—B—P—Si—Cr based alloy, or the like.

From the viewpoint of lowering the coercivity, the large particles 11 of the metal magnetic particles 10 preferably have a nanocrystalline or amorphous alloy composition and more preferably have an amorphous alloy composition. On the other hand, the small particles 12 are not limited, but from the viewpoint of saturation magnetic flux density, the small particles 12 are preferably pure iron particles, such as carbonyl iron, which has a high saturation magnetic flux density, or crystalline alloy particles, such as Fe—Ni based alloys and Fe—Si based alloys. Moreover, when the metal magnetic particles 10 include the medium particles 13, the medium particles 13 may have the same particle composition as the large particles 11 or may have a particle composition different from that of the large particles 11. The medium particles 13 are not limited either, but similarly to the large particles 11, from the viewpoint of lowering the coercivity, the medium particles 13 preferably have a nanocrystalline or amorphous alloy composition and more preferably have an amorphous alloy composition.

The composition of the metal magnetic particles 10 can be analyzed, for example, using an EDX device or EPMA attached to an electron microscope. When the large particles 11 and the small particles 12 have different particle compositions, the large particles 11 and the small particles 12 can be distinguished from each other by area analysis using an EDX device or an EPMA.

The composition of the metal magnetic particles 10 may be analyzed using a three-dimensional atom probe (3DAP). When a 3DAP is employed, an average composition can be measured by determining a small region (e.g., a region of Φ 20 nm×100 nm) inside the metal magnetic particles to be measured, and the compositions of the particle bodies can be determined by excluding the influence of the resin component contained in the magnetic core 2, the oxidation of the particle surfaces, and the like.

The crystal structure of the metal magnetic particles 10 can be analyzed using XRD, electron beam diffraction, or the like. In the present embodiment, the term “amorphous” means that the amorphous degree X is 85% or more, or that no crystal-induced spots are confirmed in electron beam diffraction. The amorphous degree X may be calculated from the area proportion between the amorphous portion and the crystallized portion using an electron microscope. The amorphous structure includes a structure that is substantially amorphous, a structure that is heteroamorphous, and the like. In the heteroamorphous structure, preferably, crystals existing in the amorphous material have an average crystal particle size of 0.1 nm or more and 10 nm or less. In the present embodiment, the term “nanocrystal” means a crystal structure having an amorphous degree X of less than 85% and an average crystal particle size of 100 nm or less (preferably, 3 nm to 50 nm), and the term “crystalline” means a crystal structure having an amorphous degree X of less than 85% and an average crystal particle size of more than 100 nm.

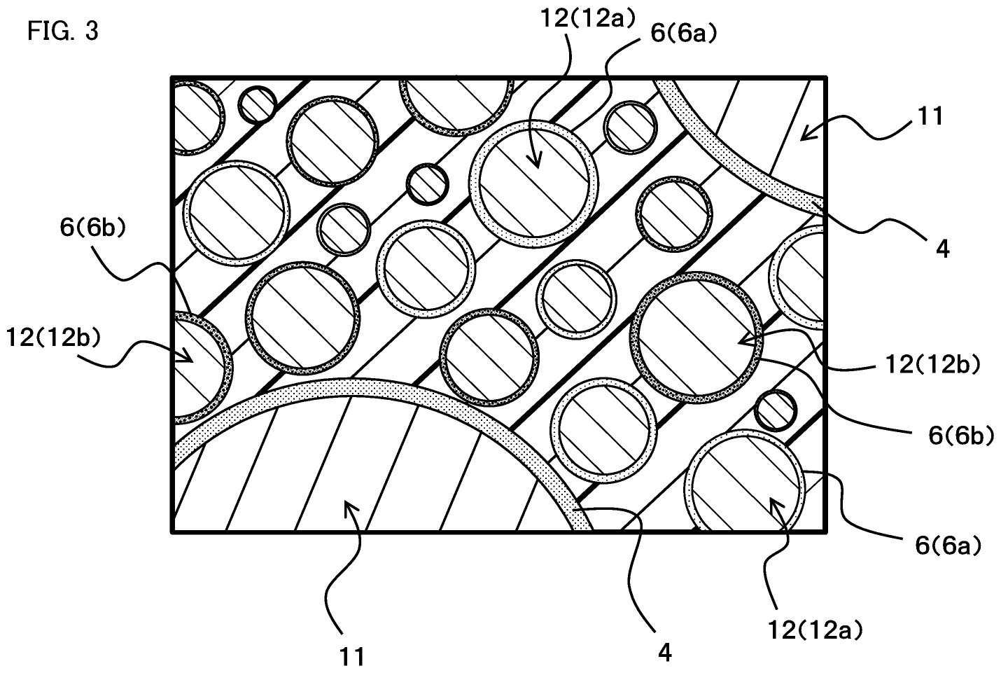

In the magnetic core 2 of the present embodiment, as shown in FIG. 3, the small particles 12 include insulating films 6 covering the particle surfaces, and the magnetic core 2 includes two or more types of small particles 12 with different compositions of the insulating films 6. In other words, the small particles 12 included in the metal magnetic particles 10 can be subdivided into two or more types of small particle groups based on the film compositions. Specifically, the small particles 12 include at least a first small particle 12a provided with a first insulating film 6a and a second small particle 12b provided with a second insulating film 6b having a composition different from that of the first insulating coating 6a and may further include a third small particle 12c to a n-th small particle 12x each having a film composition different from those of other small particle groups. “n” means the number of small particle groups when the small particles 12 are subdivided based on the film compositions, and the upper limit of “n” is not limited. From the viewpoint of simplifying the manufacturing process, “n” is preferably 4 or less.

Here, “different film compositions” means that the types of constituent elements contained in the insulating film 6 are different, and the constituent elements of the insulating film 6 are elements contained in an amount of 1 at % or more in the insulating film 6 provided that the total content rate of elements other than oxygen and carbon among the elements contained in the insulating film 6 is 100 at %. The composition of the insulating film 6 is analyzed by area analysis or point analysis using an EDX device or EPMA.

The material of each of the insulating films 6 (the first insulating film 6a, the second insulating film 6b, and the third insulating film 6c to the n-th insulating film 6x) of the small particles 12 is not limited. For example, each of the insulating films 6 is a film due to oxidation of the surfaces of the small particles 12 (oxide film) or a film containing an inorganic material, such as BN, SiO₂, MgO, Al₂O₃, phosphate, silicate, borosilicate, bismuthate, and various types of glass, and preferably includes a film of an oxide glass.

For example, the oxide glass is a silicate (SiO₂) based glass, a phosphate (P₂O₅) based glass, a bismuthate (Bi₂O₃) based glass, a borosilicate (B₂O₃—SiO₂) based glass, or the like. More specifically, for example, the silicate based glass is SiO₂ (Si—O based glass), soda glass (Si—Na—Ca—O based glass), a Si—Ba—Mn—O based glass, a Si—Mn—Ca—Na—O based glass, or the like. For example, the phosphate based glass is P₂O₅ (P—O based glass), a P—Zn—Al—O based glass, a P—Zn—Al—R—O based glass (“R” is one or more elements selected from alkali metals), or the like. For example, the bismuthate based glass is a Bi—Zn—B—Si—O based glass, a Bi—Zn—B—Si—Al—O based glass, or the like. For example, the borosilicate based glass is a Ba—Zn—B—Si—Al—O glass, or the like.

The first insulating film 6a and the second insulating film 6b have different compositions, and the combination of film compositions is not limited. For example, the combination of the first insulating film 6a and the second insulating film 6b is preferably a combination of a P—O based glass film and a P—Zn—Al—O based glass film, a combination of a Bi—Zn—B—Si—O based glass film and a Si—O-based glass film, or a combination of a Ba—Zn—B—Si—Al—O based glass film and a Si—O based glass film and is more preferably a combination of a Ba—Zn—B—Si—Al—O based glass film and a Si—O based glass film. Even when the small particles 12 include the third small particles 12c to the n-th small particles 12x in addition to the first small particles 12a and the second small particles 12b, the combination of film compositions is not limited. Preferably, the third small particles 12c to the n-th small particles 12x also have a film of an oxide glass with a composition different from that of the other small particle groups.

The average thickness of the insulating films 6 is not limited and, for example, is preferably 5 nm or more and 100 nm or less, more preferably 5 nm or more and 50 nm or less. The first insulating films 6a to the n-th insulating films 6x may have approximately the same average thickness or may have different average thicknesses.

The insulating films 6, such as the first insulating films 6a and the second insulating films 6b, may have a multilayer structure in which multiple layers are laminated. For example, the insulating films 6 may have a multilayer structure including an oxide layer on the particle surface and an oxide glass layer covering the oxide layer. When one or more types of the insulating films 6 among the first insulating film 6a to the n-th insulating films 6x have the multilayer structure, the composition of the outermost layer (layer located closest to the surface) is different in the first insulating films 6a to the n-th insulating films 6x, and the compositions of the other layers located between the outermost layer and the particle surface may be the same or different in the first insulating films 6a to the n-th insulating films 6x.

The first small particles 12a to the n-th small particles 12x may all have the same particle composition or different particle compositions. The crystal structures of the first small particles 12a to the n-th small particles 12x are not limited, and one or more types of small particle groups of the first small particles 12a to the n-th small particles 12x may be amorphous or nanocrystalline, but as described above, all of the first small particles 12a to the n-th small particles 12x are preferably crystalline.

The total area percentages of the first small particles 12a to the n-th small particles 12x in the cross section of the magnetic core 2 are set to AS₁ to ASₙ, respectively. In this case, the total area percentage AS of the small particles 12 in the cross section of the magnetic core 2 can be represented by the sum of AS₁ to ASₙ. Also, the ratio of the total area percentage of each small particle group to the total area percentage AS of the small particles 12 can be represented by AS₁/AS to ASₙ/AS, respectively. Each of AS₁/AS to ASₙ/AS is preferably 1% or more, more preferably 6% or more, and even more preferably 10% or more.

The magnetic core 2 may include the small particles 12 without the insulating films 6. In the small particles 12 including the insulating films 6, the insulating films 6 may cover the entire particle surfaces or may cover only a part of the particle surfaces. Preferably, the insulating film 6 of each of the small particles 12 covers 80% or more of the particle surface observed in the cross section of the magnetic core 2.

As shown in FIG. 3, preferably, the large particles 11 include insulating films 4 covering the particle surfaces. The material of the insulating films 4 is not limited, and the insulating films 4 can be, for example, films due to oxidation of the surfaces of the large particles 11 (oxide films) or films containing an inorganic material, such as BN, SiO₂, MgO, Al₂O₃, phosphate, silicate, borosilicate, bismuthate, and various glasses. The insulating films 4 may have a structure in which two or more types of films are laminated.

From the viewpoint of preventing a decrease in the resistivity of the magnetic core 2, preferably, the insulating films 4 of the large particles 11 include oxide glass films containing one or more elements selected from P, Si, Bi, and Zn. In the oxide glass films, the total content rate of one or more elements selected from P, Si, Bi, and Zn is preferably the highest, more preferably 50 mass % or more, and even more preferably 60 mass % or more, provided that the total content rate of elements other than oxygen is 100 mass %. For example, the above-mentioned oxide glass is a phosphate based glass, a bismuthate based glass, a borosilicate based glass, or the like. When the insulating films 4 of the large particles 11 have a multilayer structure, preferably, the oxide glass films are located on the outermost surface side (outermost layers).

The average thickness of the insulating films 4 of the large particles 11 is not limited and, for example, is preferably 5 nm or more and 200 nm or less, more preferably 5 nm or more and 150 nm or less, and even more preferably 10 nm or more and 50 nm or less.

When the metal magnetic particles 10 include the medium particles 13, similarly to the other particle groups, it is preferable that the medium particles 13 also have insulating films covering the particle surfaces. The compositions of the insulating films of the medium particles 13 are not limited and may be the same as those of the insulating films 4 of the large particles 11 or may be different from those of the insulating films 4 of the large particles 11. The average thickness of the insulating films of the medium particles 13 is not limited and is preferably 5 nm or more and 200 nm or less, more preferably 10 nm or more and 50 nm or less.

The magnetic core 2 may include the large particles 11 and the medium particles 13 without insulating films. Both of the insulating films 4 of the large particles 11 and the insulating films of the medium particles 13 may cover the entire particle surfaces or only a part of the particle surfaces and preferably cover 80% or more of the particle surfaces observed in the cross section of the magnetic core 2.

The average circularity of the large particles 11 in the cross section of the magnetic core 2 is preferably 0.90 or more, more preferably 0.95 or more. The higher the average circularity of the large particles 11 is, the further the withstand voltage and DC bias characteristics are improved. The circularity of each of the large particles 11 is represented by 2(πS_{L})^{1/2}L, where S_{L} is an area of each of the large particles 11 in the cross section of the magnetic core 2, and L is a circumferential length of each of the large particles 11. The circularity of a perfect circle is 1. The closer the circularity is to 1, the higher the spheroidicity of the particle becomes. Preferably, the average circularity of the large particles 11 is calculated by measuring the circularities of at least 100 large particles 11.

The average circularity of the small particles 12 and the average circularity of the medium particles 13 are not limited, but are preferably high, similarly to the large particles 11. Specifically, preferably, both of the small particles 12 and the medium particles 13 have an average circularity of 0.80 or more.

The resin 20 functions as an insulating binder for fixing the metal magnetic particles 10 in a predetermined dispersed state. The material of the resin 20 is not limited, and the resin 20 preferably includes a thermosetting resin such as epoxy resin.

The magnetic core 2 may include a modifier for preventing contact between the soft magnetic metal particles. The modifier can be a polymeric material, such as polyethylene glycol (PEG), polypropylene glycol (PPG), and polycaprolactone (PCL), and it is preferable to employ a polymeric material having a polycaprolactone structure. Polymers having a polycaprolactone structure include, for example, raw materials for urethane such as polycaprolactone diol and polycaprolactone tetraol or a part of polyesters. Preferably, the amount of the modifier is 0.025 wt % or more and 0.500 wt % or less with respect to the total amount of the magnetic core 2. It is conceivable that the above-described modifier is adsorbed and present so as to coat the surfaces of the metal magnetic particles 10.

Hereinafter, an example of a method of manufacturing a magnetic core 2 according to the present embodiment is described.

First, a raw material powder including large particles 11 and a raw material powder including small particles 12 are produced as raw material powders for metal magnetic particles 10. The method of producing each of the raw material powders is not limited, and an appropriate production method is employed according to the desired particle composition. For example, the raw material powders may be produced by an atomizing method, such as a water atomizing method and a gas atomizing method. Instead, the raw material powders may be produced by a synthesis method such as a CVD method using at least one of metal salt evaporation, reduction, and thermal decomposition. Moreover, the raw material powders may be produced by using an electrolysis method or a carbonyl method or may be produced by pulverizing a starting alloy in the form of ribbons or thin plates. The particle size of each raw material powder can be adjusted by production conditions and various classification methods of powders. The produced raw material powders may be subjected to a heat treatment for controlling the crystal structure of the metal magnetic particles 10.

When the large particles 11 and the small particles 12 have the same composition, a raw material powder including the large particles 11 and a raw material powder including the small particles 12 may be obtained by producing a raw material powder having a wide particle size distribution and classifying this raw material powder. When two or more types of small particles 12 with different particle compositions are added to the magnetic core 2, a plurality of raw material powders for small particles is produced. In addition, when medium particles 13 are added to the magnetic core 2, a raw material powder including the medium particles 13 is produced by any of the above-described production methods.

Next, each of the raw material powders is subjected to a film formation treatment. For example, the film formation treatment is a heat treatment, a phosphate treatment, a mechanical alloying, a silane coupling treatment, a hydrothermal synthesis, or the like, and an appropriate film formation treatment is selected according to the type of insulation film to be formed.

For example, when the insulating films 4 containing oxide glass are formed on the large particles 11, it is preferable to employ a mechanochemical method using a mechanofusion apparatus. Specifically, in the film formation process by the mechanochemical method, a raw material powder including the large particles 11 and powdery coating materials containing constituent elements of the insulating films 4 are introduced into a rotary rotor of the mechanofusion apparatus, and the rotary rotor is rotated. A press head is installed inside the rotary rotor. When the rotary rotor is rotated, the mixture of the raw material powder and the coating materials is compressed in the gap between the inner wall surface of the rotary rotor and the press head, and a frictional heat is generated. The coating material is softened by the frictional heat and adhered to the surfaces of the large particles 11 by compression effect, and insulating films 4 are formed. When insulating films having the same compositions as the insulating films 4 of the large particles 11 are formed on the surfaces of the medium particles 13, the raw material powder including the large particles 11 and the raw material powder including the medium particles 13 are mixed, and this mixed powder is subjected to the above-mentioned film formation treatment.

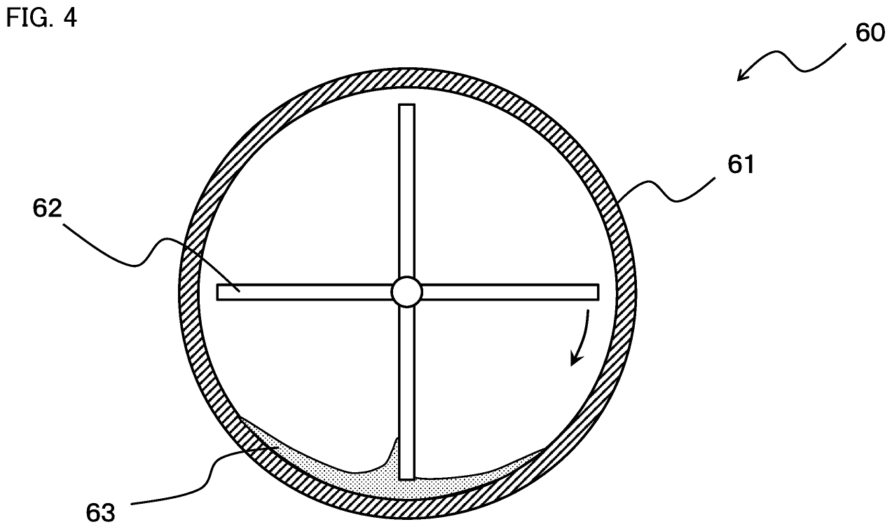

The insulating films 6 of the small particles 12 are preferably formed by mixing the raw material powder including the small particles 12 and the powdery coating materials containing constituent elements of the insulating films 6 while applying a mechanical impact energy and are more preferably formed by mixing the raw material powder including the small particles 12 and the powdery coating materials containing constituent elements of the insulating films 6 while applying energies of impact, compression, and shearing. In such a film formation treatment, as an apparatus capable of applying a mechanical energy to the powders, it is possible to employ a powder treatment apparatus such as a planetary ball mill and Nobilta manufactured by Hosokawa Micron Corporation. In the film formation treatment for the small particles 12, for example, it is possible to employ a powder processing apparatus 60 capable of performing a mixing at a high rotational speed as shown in FIG. 4.

The powder processing apparatus 60 has a cylindrical cross section and is provided with a chamber 61, and rotatable vanes 62 are placed inside the chamber 61. Energies of impact, compression, and shearing can be applied to a mixture 63 of the raw material powder and the coating materials by putting the raw material powder including the small particles 12 and the coating materials into the chamber 61 and rotating the vanes 62 at a rotation speed of 2000 to 6000 rpm. With the powder processing apparatus 60, it is possible to form the insulating films 6 on the surfaces of even the small particles 12 having small particle sizes.

Two or more types of small particle powders with different film compositions are produced by the above-mentioned film formation treatment. The film compositions are controlled by the type and composition of the coating materials mixed with the raw material powders. The thicknesses of the insulating films 6 are controlled based on the mixing ratio of the coating materials, the rotation speed, the treatment time, and the like.

Hereinafter, a method of manufacturing the magnetic core 2 using each of the raw material powders of the metal magnetic particles 10 is described. First, the raw material powders with the insulating films and a resin raw material (thermosetting resin, etc.) are kneaded to obtain a resin compound. In this kneading step, a kneading machine, such as a kneader, a planetary mixer, a planetary centrifugal mixer, and a twin-screw extruder, may be used. Modifiers, preservatives, dispersants, non-magnetic powders, etc. may be added to the resin compound.

Next, the resin compound is filled in a mold and subjected to a compression molding to obtain a molded body. The molding pressure at this time is not limited and is preferably, for example, 50 MPa or more and 1200 MPa or less. The total area percentage of the metal magnetic particles 10 in the magnetic core 2 can be controlled by the addition amount of the resin 20, but can also be controlled by the molding pressure. When the resin 20 is a thermosetting resin, the above-mentioned molded body is held at 100° C. to 200° C. for 1 hour to 5 hours to cure the thermosetting resin. Through the above-mentioned steps, the magnetic core 2 as shown in FIG. 1 is obtained.

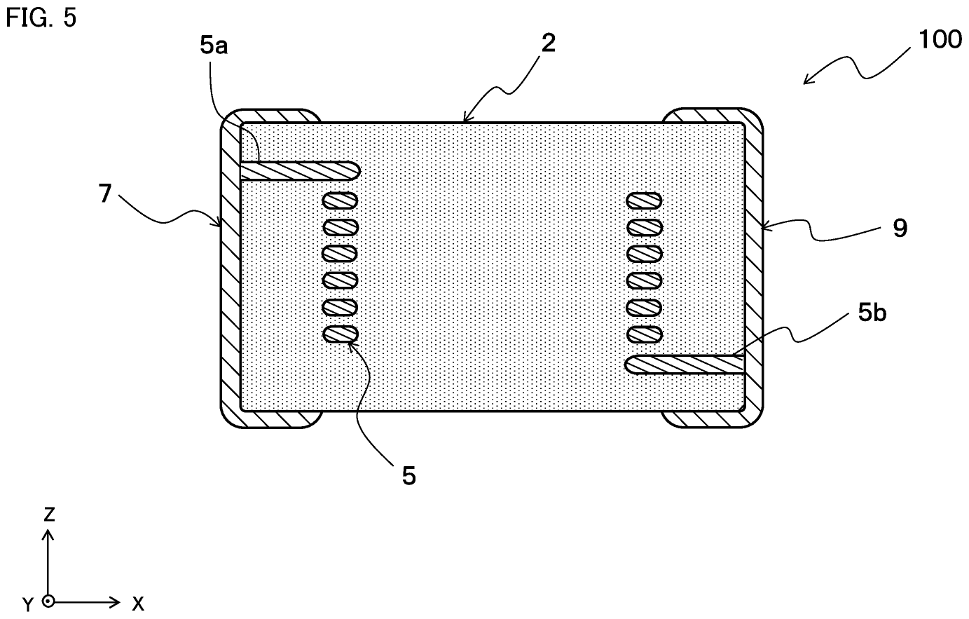

The magnetic core 2 according to the present embodiment can be applied to various magnetic devices, such as inductors, transformers, and choke coils. For example, a magnetic device 100 shown in FIG. 5 is an example of a magnetic device including the magnetic core 2.

In the magnetic device 100 shown in FIG. 5, the element body is comprised of the magnetic core 2 as shown in FIG. 1. A coil 5 is embedded in the magnetic core 2 (element body), and ends 5a and 5b of the coil 5 are drawn out to the end surfaces of the magnetic core 2, respectively. A pair of external electrodes 7 and 9 is formed on the end surfaces of the magnetic core 2, and the pair of external electrodes 7 and 9 is electrically connected to the ends 5a and 5b of the coil 5, respectively. When the coil 5 is embedded in the magnetic core 2 as in the magnetic device 100, the area percentages of the metal magnetic particles 10, such as A0, A1, A2, AL, and AS, are analyzed in a field of view where the coil 5 is not displayed.

The application of the magnetic device 100 shown in FIG. 5 is not limited, but is suitable, for example, as a power inductor used in a power supply circuit. Note that, the magnetic device including the magnetic core 2 is not limited to the mode as shown in FIG. 5 and may be a magnetic device in which a wire is wound by a predetermined number of turns on the surface of the magnetic core 2 having a predetermined shape.

### Summary of Embodiment

The magnetic core 2 of the present embodiment includes the metal magnetic particles 10 and the resin 20, and the total area percentage A0 of the metal magnetic particles 10 in the cross section of the magnetic core 2 is 75% or more and 90% or less. The metal magnetic particles 10 include the first particles 10a (large particles 11) having Heywood diameters of 3 μm or more and the second particles 10b (small particles 12) having Heywood diameters of less than 3 μm, and the second particles 10b include two or more types of small particles 12 (the first small particles 12a, the second small particles 12b, and the like) having different compositions of films existing on the particle surfaces.

The magnetic core 2 having the above-mentioned characteristics exhibits DC bias characteristics superior to those of conventional ones. The reason why the DC bias characteristics are improved is not necessarily clear, but it is conceivable that the dispersion state of the metal magnetic particles 10 inside the magnetic core 2 has an effect. Specifically, it is conceivable that, since the metal magnetic particles 10 include two or more types of small particles 12 with different film compositions, the electrical repulsive force between the metal magnetic particles is improved during kneading with the resin, and the magnetic aggregation of the metal magnetic particles 10 is prevented.

In the cross section of the magnetic core 2, the area percentage of the metal magnetic particles 10 preferably satisfies A1>A2, where A1 is a total area percentage of the first particles 10a, and A2 is a total area percentage of the second particles 10b. In other words, AL is preferably larger than AS (AL>AS), where AL is a total area percentage of the large particles 11 in the cross section of the magnetic core 2, and AS is a total area percentage of the small particles 12 in the cross section of the magnetic core 2. The magnetic permeability of the magnetic core 2 can be improved by satisfying the above-mentioned requirements

Preferably, the large particles 11 contained in the magnetic core 2 have an average circularity of 0.90 or more. When the large particles 11 have high circularities, the DC bias characteristics can be further improved.

Hereinabove, an embodiment of the present disclosure is described, but the present disclosure is not limited to the above-described embodiment and variously be modified within the scope of the gist of the present disclosure.

For example, a magnetic device may be manufactured by combining a plurality of magnetic cores 2. Moreover, the method of manufacturing the magnetic core 2 is not limited to the method shown in the above-mentioned embodiment, and the magnetic core 2 may be manufactured by a sheet method or injection molding or may be manufactured by two-stage compression. In the manufacturing method by two-stage compression, for example, the magnetic core 2 is obtained by preliminarily compressing a resin compound to produce a plurality of preliminary molded bodies and thereafter combining the preliminary molded bodies and subjecting them to a main compression.

### EXAMPLES

Hereinafter, the present disclosure is described in more detail based on specific examples. However, the present disclosure is not limited to the following examples.

### Experiment 1

In Experiment 1, magnetic cores according to Examples shown in Table 1 to Table 3 were manufactured in the following procedure.

First, a large-diameter powder and a small-diameter powder were prepared as raw material powders for metal magnetic particles. In each of Sample A1 to Sample A21 shown in Table 1, an amorphous Fe—Co—B—P—Si—Cr based alloy powder produced by a quenching gas atomization method was used as the large-diameter powder, and the average particle size of this powder was 20 μm. In each of Sample B1 to Sample B21 shown in Table 2, a nanocrystalline Fe—Si—B—Nb—Cu based alloy powder whose average particle size was 20 μm was used as the large-diameter powder, and this Fe—Si—B—Nb—Cu based alloy powder was produced by subjecting a powder obtained by a quenching gas atomization method to a heat treatment. In each of Sample C1 to Sample C21 shown in Table 3, a crystalline Fe—Si based alloy powder produced by a gas atomization method was used as the large-diameter powder, and the average particle size of this powder was 20 μm. In each Sample of Experiment 1, insulating films composed of P—Zn—Al—O based oxide glass and having an average thickness of 20 nm were formed on the surfaces of large particles contained in the large-diameter powder using a mechanofusion apparatus (AMS-Lab manufactured by Hosokawa Micron Corporation).

In Sample A1 to Sample A6, Sample B1 to Sample B6, and Sample C1 to Sample C6 (Comparative Examples), one type of pure iron powder including an insulating film was prepared as the small-diameter powder. On the other hand, in Sample A7 to Sample A21, Sample B7 to Sample B21, and Sample C7 to Sample C21 (Examples), two types of pure iron powders with different film compositions were prepared as the small-diameter powder. In each of Samples of Experiment 1, the insulating films of the small-particles were formed using a powder processing apparatus (Nobilta manufactured by Hosokawa Micron Corporation) as shown in FIG. 4, and their film compositions were those shown in Table 1 to Table 3. The average particle size of the pure iron powder used in each of Samples in Experiment 1 was 1 μm, and the average thickness of the insulating films formed on the surfaces of the small particles was within the range of 15±10 nm.

Next, the raw material powders (the large-diameter powder and the small-diameter powder) of the metal magnetic particles and an epoxy resin were kneaded to obtain a resin compound. At this time, in all of Samples of Experiment 1, the addition amount of the epoxy resin (resin amount) in the resin compound was 2.5 wt % with respect to 100 parts by mass of the metal magnetic particles. A toroidal-shaped molded body was obtained by filling the above-mentioned resin compound into a mold and pressurizing it. The molding pressure at this time was controlled so that the magnetic permeability (μi) of the magnetic core was 30. Then, the molded body was heated at 180° C. for 60 minutes to cure the epoxy resin in the molded body, and a toroidal-shaped magnetic core (outer diameter: 11 mm, inner diameter: 6.5 mm, thickness: 2.5 mm) was obtained.

In each of Samples of Experiment 1, the following evaluations were performed on the manufactured magnetic core.

### Observation of Cross Section of Magnetic Core

A cross section of the magnetic core was observed with an SEM, and a ratio of a total area of the metal magnetic particles to a total area (1,000,000 μm²) of observation fields (a total area percentage A0 of the metal magnetic particles) was calculated. In each of samples of Experiment 1, the total area percentage A0 of the metal magnetic particles was within the range of 80±2%.

In the SEM observation, a Haywood diameter of each of the metal magnetic particles was measured, an area analysis by EDX was performed to determine the composition system of each of the metal magnetic particles, and the metal magnetic particles observed in the cross section of the magnetic core were divided into large particles and small particles. In each of Samples of Experiment 1, D20 of the large particles was 3 μm or more, the average particle size (the arithmetic mean value of Heywood diameters) of the large particles was within the range of 10 μm to 30 μm, D80 of the small particles was less than 3 μm, and the average particle size of the small particles was within the range of 0.5 μm to 1.5 μm.

The composition of the insulating films formed on the small particles were determined by the above-mentioned area analysis, and the small particles observed in the cross section of the magnetic core were subdivided into first small particles and second small particles based on the determined film compositions. In Experiment 1, in all of Samples, insulating films having the desired compositions were formed on the surfaces of the small particles.

After classifying the metal magnetic particles into a plurality of particle groups (large particles, first small particles, and second small particles) by the above-mentioned method, a total area of each of the particle groups was calculated. Then, a ratio of each of the particle groups contained in the metal magnetic particles was calculated from the total area of each of the particle groups. The ratio of each of the particle groups are represented by a ratio of the total area of the large particles to the total area of the metal magnetic particles (AL/A0), a ratio of the total area of the first small particles to the total area of the metal magnetic particles (AS₁/A0), and a ratio of the total area of the second small particles to the total area of the metal magnetic particles (AS₂ /A0), where A0 is a sum of AL, AS₁, and AS₂. The calculation results are shown in Table 1 to Table 3.

### Evaluation of DC Bias Characteristics

In the evaluation of DC bias characteristics, first, a polyurethane enameled copper wire (UEW wire) was wound around the toroidal-shaped magnetic core. Then, an inductance of the magnetic core at a frequency of 1 MHz was measured using an LCR meter (4284A manufactured by Agilent Technologies) and a DC bias power supply (42841A manufactured by Agilent Technologies). More specifically, an inductance under the condition where no DC magnetic field was applied (0 kA/m) and an inductance under the condition where a DC magnetic field of 8 kA/m was applied were measured, and μi (magnetic permeability at 0 A/m) and μHdc (magnetic permeability at 8 kA/m) were calculated from the inductances. The DC bias characteristics were evaluated based on the change rate in magnetic permeability when the DC magnetic field was applied. That is, the change rate in magnetic permeability was represented by (μi-μHdc)/μi, and it can be determined that the smaller the change rate in magnetic permeability was, the better the DC bias characteristics were.

When the amorphous large particles were employed, a sample having a change rate in magnetic permeability of 10% or less was considered to be good. When the nanocrystal or crystalline large particles were employed, a sample having a change rate in magnetic permeability of 15% or less was considered to be good. The calculation results are shown in Table 1 to Table 3.

TABLE 1

| | | Metal Magnetic Particles | | | | |
|---|---|---|---|---|---|---|
| | Example/ | Large | First Small Particles | | Second Small Particles | |
| Sample | Comparative | Particles | Particle | Film | Particle | Film |
| No. | Example | Structure | Composition | Composition | Composition | Composition |
| A1 | comp. ex. | amorphous | Fe | P—O | — | — |
| A2 | comp. ex. | amorphous | Fe | P—Zn—Al—O | — | — |
| A3 | comp. ex. | amorphous | Fe | Bi—Zn—B—Si—O | — | — |
| A4 | comp. ex. | amorphous | Fe | Ba—Zn—B—Si—Al—O | — | — |
| A5 | comp. ex. | amorphous | Fe | Si—O | — | — |
| A6 | comp. ex. | amorphous | Fe | Si—Ba—Mn—O | — | — |
| A7 | ex. | amorphous | Fe | P—O | Fe | P—Zn—Al—O |
| A8 | ex. | amorphous | Fe | P—O | Fe | Bi—Zn—B—Si—O |
| A9 | ex. | amorphous | Fe | P—O | Fe | Ba—Zn—B—Si—Al—O |
| A10 | ex. | amorphous | Fe | P—O | Fe | Si—O |
| A11 | ex. | amorphous | Fe | P—O | Fe | Si—Ba—Mn—O |
| A12 | ex. | amorphous | Fe | P—Zn—Al—O | Fe | Bi—Zn—B—Si—O |
| A13 | ex. | amorphous | Fe | P—Zn—Al—O | Fe | Ba—Zn—B—Si—Al—O |
| A14 | ex. | amorphous | Fe | P—Zn—Al—O | Fe | Si—O |
| A15 | ex. | amorphous | Fe | P—Zn—Al—O | Fe | Si—Ba—Mn—O |
| A16 | ex. | amorphous | Fe | Bi—Zn—B—Si—O | Fe | Ba—Zn—B—Si—Al—O |
| A17 | ex. | amorphous | Fe | Bi—Zn—B—Si—O | Fe | Si—O |
| A18 | ex. | amorphous | Fe | Bi—Zn—B—Si—O | Fe | Si—Ba—Mn—O |
| A19 | ex. | amorphous | Fe | Ba—Zn—B—Si—Al—O | Fe | Si—O |
| A20 | ex. | amorphous | Fe | Ba—Zn—B—Si—Al—O | Fe | Si—Ba—Mn—O |
| A21 | ex. | amorphous | Fe | Si—O | Fe | Si—Ba—Mn—O |

| | Proportion of Particle Groups | | | | | |
|---|---|---|---|---|---|---|
| | (In Terms of Area Proportion) | | | | | |
| | | First | Second | | | |
| | Large | Small | Small | Magnetic Permeability | | |
| | Particles | Particles | Particles | | | Change |
| Sample | AL/A0 | AS/A0 | AS2/A0 | μi | μHdc | Rate |
| No. | (%) | (%) | (%) | 0A/m | 8kA/m | (%) |
| A1 | 79.9 | 20.1 | — | 31.4 | 27.1 | 13.7 |
| A2 | 80.0 | 20.0 | — | 30.7 | 26.5 | 13.5 |
| A3 | 80.5 | 19.5 | — | 31.3 | 26.8 | 14.4 |
| A4 | 80.4 | 19.6 | — | 30.6 | 26.5 | 13.5 |
| A5 | 80.1 | 19.9 | — | 31.1 | 26.1 | 16.2 |
| A6 | 79.9 | 20.1 | — | 30.9 | 26.4 | 14.6 |
| A7 | 80.0 | 10.4 | 9.6 | 30.8 | 28.8 | 6.6 |
| A8 | 80.0 | 10.1 | 9.9 | 31.5 | 28.9 | 8.2 |
| A9 | 80.3 | 10.1 | 9.6 | 30.6 | 27.7 | 9.6 |
| A10 | 79.9 | 10.1 | 9.9 | 31.4 | 28.4 | 9.6 |
| A11 | 80.1 | 10.3 | 9.7 | 31.1 | 28.1 | 9.7 |
| A12 | 79.8 | 10.0 | 10.2 | 31.1 | 28.8 | 7.4 |
| A13 | 79.9 | 10.4 | 9.7 | 31.4 | 28.9 | 7.9 |
| A14 | 79.9 | 10.0 | 10.1 | 30.6 | 28.4 | 7.3 |
| A15 | 79.9 | 9.9 | 10.2 | 30.9 | 28.3 | 8.5 |
| A16 | 79.7 | 10.3 | 10.0 | 31.1 | 28.6 | 7.9 |
| A17 | 80.2 | 9.6 | 10.2 | 31.0 | 28.8 | 7.0 |
| A18 | 79.7 | 10.3 | 10.0 | 31.1 | 28.7 | 7.6 |
| A19 | 80.4 | 9.7 | 9.8 | 30.5 | 28.6 | 6.3 |
| A20 | 79.8 | 10.4 | 9.9 | 31.4 | 28.9 | 8.0 |
| A21 | 79.5 | 10.0 | 10.5 | 30.8 | 28.5 | 7.6 |

TABLE 2

| | | Metal Magnetic Particles | | | | |
|---|---|---|---|---|---|---|
| | | Large | First Small Particles | | Second Small Particles | |
| Sample | Ex./ | Particles | Particle | Film | Particle | Film |
| No. | Comp. Ex. | Structure | Composition | Composition | Composition | Composition |
| B1 | comp. ex. | nanocrystalline | Fe | P—O | — | — |
| B2 | comp. ex. | nanocrystalline | Fe | P—Zn—Al—O | — | — |
| B3 | comp. ex. | nanocrystalline | Fe | Bi—Zn—B—Si—O | — | — |
| B4 | comp. ex. | nanocrystalline | Fe | Ba—Zn—B—Si—Al—O | — | — |
| B5 | comp. ex. | nanocrystalline | Fe | Si—O | — | — |
| B6 | comp. ex. | nanocrystalline | Fe | Si—Ba—Mn—O | — | — |
| B7 | ex. | nanocrystalline | Fe | P—O | Fe | P—Zn—Al—O |
| B8 | ex. | nanocrystalline | Fe | P—O | Fe | Bi—Zn—B—Si—O |
| B9 | ex. | nanocrystalline | Fe | P—O | Fe | Ba—Zn—B—Si—Al—O |
| B10 | ex. | nanocrystalline | Fe | P—O | Fe | Si—O |
| B11 | ex. | nanocrystalline | Fe | P—O | Fe | Si—Ba—Mn—O |
| B12 | ex. | nanocrystalline | Fe | P—Zn—Al—O | Fe | Bi—Zn—B—Si—O |
| B13 | ex. | nanocrystalline | Fe | P—Zn—Al—O | Fe | Ba—Zn—B—Si—Al—O |
| B14 | ex. | nanocrystalline | Fe | P—Zn—Al—O | Fe | Si—O |
| B15 | ex. | nanocrystalline | Fe | P—Zn—Al—O | Fe | Si—Ba—Mn—O |
| B16 | ex. | nanocrystalline | Fe | Bi—Zn—B—Si—O | Fe | Ba—Zn—B—Si—Al—O |
| B17 | ex. | nanocrystalline | Fe | Bi—Zn—B—Si—O | Fe | Si—O |
| B18 | ex. | nanocrystalline | Fe | Bi—Zn—B—Si—O | Fe | Si—Ba—Mn—O |
| B19 | ex. | nanocrystalline | Fe | Ba—Zn—B—Si—Al—O | Fe | Si—O |
| B20 | ex. | nanocrystalline | Fe | Ba—Zn—B—Si—Al—O | Fe | Si—Ba—Mn—O |
| B21 | ex. | nanocrystalline | Fe | Si—O | Fe | Si—Ba—Mn—O |

| | Proportion of Particle Groups | | | | | |
|---|---|---|---|---|---|---|
| | (In Terms of Area Proportion) | | | | | |
| | | First | Second | | | |
| | Large | Small | Small | Magnetic Permeability | | |
| | Particles | Particles | Particles | | | Change |
| Sample | AL/A0 | AS/A0 | AS2/A0 | μi | μHdc | Rate |
| No. | (%) | (%) | (%) | 0A/m | 8kA/m | (%) |
| B1 | 79.8 | 20.2 | — | 31.1 | 24.8 | 20.2 |
| B2 | 79.6 | 20.4 | — | 31.1 | 25.1 | 19.4 |
| B3 | 79.5 | 20.5 | — | 30.7 | 24.7 | 19.6 |
| B4 | 79.7 | 20.3 | — | 30.5 | 24.7 | 19.1 |
| B5 | 79.9 | 20.1 | — | 31.4 | 25.0 | 20.5 |
| B6 | 80.2 | 19.8 | — | 31.2 | 24.9 | 20.3 |
| B7 | 79.8 | 10.4 | 9.7 | 31.4 | 27.0 | 14.0 |
| B8 | 80.2 | 9.5 | 10.3 | 30.6 | 26.4 | 13.7 |
| B9 | 79.9 | 9.7 | 10.3 | 31.2 | 26.8 | 14.1 |
| B10 | 79.5 | 10.2 | 10.3 | 30.7 | 26.5 | 13.9 |
| B11 | 79.7 | 9.9 | 10.4 | 30.7 | 26.5 | 13.6 |
| B12 | 79.7 | 10.1 | 10.2 | 31.1 | 26.7 | 14.2 |
| B13 | 79.8 | 9.5 | 10.7 | 31.0 | 26.5 | 14.6 |
| B14 | 79.7 | 9.5 | 10.8 | 30.7 | 26.4 | 14.2 |
| B15 | 79.9 | 10.0 | 10.1 | 30.7 | 26.1 | 14.9 |
| B16 | 80.0 | 10.3 | 9.7 | 31.3 | 26.7 | 14.7 |
| B17 | 80.2 | 9.9 | 9.9 | 31.0 | 26.8 | 13.4 |
| B18 | 79.9 | 10.0 | 10.1 | 31.0 | 26.5 | 14.6 |
| B19 | 80.4 | 9.6 | 10.0 | 31.0 | 26.8 | 13.6 |
| B20 | 80.3 | 10.3 | 9.4 | 31.0 | 26.5 | 14.6 |
| B21 | 80.4 | 9.8 | 9.8 | 31.4 | 27.0 | 14.1 |

TABLE 3

| | | | | | | | Proportion of Particle | | | | | |
|---|---|---|---|---|---|---|---|---|---|---|---|---|
| | | | | | | | Groups (In Terms | | | | | |
| | | | | | | | of Area Proportion) | | | | | |
| | | | | | | | | First | Second | | | |
| | | | | | | | Large | Small | Small | | | |
| | | Metal Magnetic Particles | | | | | Parti- | Parti- | Parti- | Magnetic | | |
| | | | First Small Particles | | Second Small Particles | | cles | cles | cles | Permeability | | |
| Sam- | Ex./ | Large | Particle | | Particle | | AL/ | AS₁/ | AS₂/ | μi | μHdc | Change |
| ple | Comp. | Particles | Compo- | Film | Compo- | Film | A0 | A0 | A0 | 0A/ | 8 kA/ | Rate |
| No. | Ex. | Structure | sition | Composition | sition | Composition | (%) | (%) | (%) | m | m | (%) |
| C1 | comp. | crystalline | Fe | P—O | — | — | 80.0 | 20.0 | — | 31.3 | 25.5 | 18.8 |
| | ex. | | | | | | | | | | | |
| C2 | comp. | crystalline | Fe | P—Zn—Al—O | — | — | 79.9 | 20.1 | — | 31.1 | 24.6 | 20.9 |
| | ex. | | | | | | | | | | | |
| C3 | comp. | crystalline | Fe | Bi—Zn—B—Si—O | — | — | 80.2 | 19.8 | — | 30.7 | 25.3 | 17.7 |
| | ex. | | | | | | | | | | | |
| C4 | comp. | crystalline | Fe | Ba—Zn—B—Si—Al—O | — | — | 80.1 | 19.9 | — | 31.2 | 24.7 | 20.9 |
| | ex. | | | | | | | | | | | |
| C5 | comp. | crystalline | Fe | Si—O | — | — | 79.6 | 20.4 | — | 30.9 | 25.4 | 17.9 |
| | ex. | | | | | | | | | | | |
| C6 | comp. | crystalline | Fe | Si—Ba—Mn—O | — | — | 79.6 | 20.4 | — | 30.6 | 25.0 | 18.4 |
| | ex. | | | | | | | | | | | |
| C7 | ex. | crystalline | Fe | P—O | Fe | P—Zn—Al—O | 80.4 | 10.4 | 9.3 | 31.3 | 27.5 | 12.0 |
| C8 | ex. | crystalline | Fe | P—O | Fe | Bi—Zn—B—Si—O | 79.6 | 9.6 | 10.8 | 30.7 | 26.4 | 14.0 |
| C9 | ex. | crystalline | Fe | P—O | Fe | Ba—Zn—B—Si—Al—O | 79.5 | 9.5 | 11.0 | 31.3 | 26.8 | 14.5 |
| C10 | ex. | crystalline | Fe | P—O | Fe | Si—O | 80.3 | 10.3 | 9.5 | 31.2 | 26.7 | 14.4 |
| C11 | ex. | crystalline | Fe | P—O | Fe | Si—Ba—Mn—O | 80.3 | 10.3 | 9.3 | 31.1 | 26.6 | 14.6 |
| C12 | ex. | crystalline | Fe | P—Zn—Al—O | Fe | Bi—Zn—B—Si—O | 79.5 | 9.5 | 11.0 | 30.6 | 26.7 | 12.9 |
| C13 | ex. | crystalline | Fe | P—Zn—Al—O | Fe | Ba—Zn—B—Si—Al—O | 79.7 | 9.7 | 10.6 | 31.2 | 27.1 | 13.2 |
| C14 | ex. | crystalline | Fe | P—Zn—Al—O | Fe | Si—O | 79.7 | 9.7 | 10.5 | 31.3 | 26.7 | 14.7 |
| C15 | ex. | crystalline | Fe | P—Zn—Al—O | Fe | Si—Ba—Mn—O | 80.2 | 10.2 | 9.7 | 30.9 | 26.6 | 14.0 |
| C16 | ex. | crystalline | Fe | Bi—Zn—B—Si—O | Fe | Ba—Zn—B—Si—Al—O | 79.7 | 9.7 | 10.7 | 31.3 | 27.3 | 12.9 |
| C17 | ex. | crystalline | Fe | Bi—Zn—B—Si—O | Fe | Si—O | 79.5 | 9.5 | 10.9 | 30.6 | 26.8 | 12.5 |
| C18 | ex. | crystalline | Fe | Bi—Zn—B—Si—O | Fe | Si—Ba—Mn—O | 80.1 | 10.1 | 9.9 | 31.0 | 26.4 | 14.8 |
| C19 | ex. | crystalline | Fe | Ba—Zn—B—Si—Al—O | Fe | Si—O | 80.3 | 10.3 | 9.5 | 31.5 | 27.2 | 13.6 |
| C20 | ex. | crystalline | Fe | Ba—Zn—B—Si—Al—O | Fe | Si—Ba—Mn—O | 80.5 | 10.5 | 9.0 | 30.9 | 26.9 | 12.7 |
| C21 | ex. | crystalline | Fe | Si—O | Fe | Si—Ba—Mn—O | 79.9 | 9.9 | 10.2 | 30.8 | 26.7 | 13.3 |

As shown in Table 1 to Table 3, Examples, which included two types of small particles (first small particles and second small particles) with different film compositions, had a change rate in magnetic permeability lower than that of Comparative Examples, which included only one type of small particles. That is, when the metal magnetic particles in the magnetic core included two types of small particles with different film compositions, the DC bias characteristics superior to conventional ones were obtained.

Comparing Examples in Table 1 to Table 3, when the amorphous large particles were employed, the change rate in magnetic permeability was further lower than that when the nanocrystalline or crystalline large particles were employed, and the improvement effect on the DC bias characteristics relative to Comparative Examples was further enhanced.

### Experiment 2

In Experiment 2, the magnetic core samples shown in Table 4 to Table 6 were manufactured by changing the ratio of the first small particles (AS₁/A0) and the ratio of the second small particles (AS₂/A0) in the metal magnetic particles. In each of Samples shown in Table 4 to Table 6, the total area percentage A0 of the metal magnetic particles in the cross section of the magnetic core was within the range of 80±2%, and the ratio of the total area of the large particles to the total area of the metal magnetic particles (AL/A0) was within the range of 80±1%. In Examples shown in Table 4 to Table 6, except for changing the ratios of the particle groups, the manufacturing conditions were the same as those of Sample A19 of Experiment 1, and the same evaluations as in Experiment 1 were performed.

TABLE 4

| | | Metal Magnetic Particles | | | | | Proportion of Particle Groups | | | | | |
|---|---|---|---|---|---|---|---|---|---|---|---|---|
| | | | | | Second Small | | | First | Second | Magnetic | | |
| | | | First Small Particles | | Particles | | Large | Small | Small | Permeability | | |
| | | Large | Particle | | Particle | Film | Particles | Particles | Particles | μi | μHdc | Change |
| Sample | Ex./ | Particles | Compo- | Film | Compo- | Compo- | AL/A0 | AS₁/A0 | AS₂/A0 | 0A/ | 8 kA/ | Rate |
| No. | Comp. Ex. | Structure | sition | Composition | sition | sition | (%) | (%) | (%) | m | m | (%) |
| A4 | comp. ex. | amorphous | Fe | Ba—Zn—B—Si—Al—O | — | — | 80.4 | 19.6 | — | 30.6 | 26.5 | 13.5 |
| D1 | ex. | amorphous | Fe | Ba—Zn—B—Si—Al—O | Fe | Si—O | 79.7 | 19.6 | 0.7 | 30.6 | 27.6 | 9.8 |
| D2 | ex. | amorphous | Fe | Ba—Zn—B—Si—Al—O | Fe | Si—O | 80.3 | 18.4 | 1.3 | 30.4 | 28.5 | 6.3 |
| A19 | ex. | amorphous | Fe | Ba—Zn—B—Si—Al—O | Fe | Si—O | 80.4 | 9.7 | 9.8 | 30.5 | 28.6 | 6.3 |
| D3 | ex. | amorphous | Fe | Ba—Zn—B—Si—Al—O | Fe | Si—O | 80.2 | 1.0 | 18.7 | 30.5 | 28.2 | 7.5 |
| D4 | ex. | amorphous | Fe | Ba—Zn—B—Si—Al—O | Fe | Si—O | 80.1 | 0.1 | 19.8 | 30.4 | 27.9 | 8.2 |
| A5 | comp. ex. | amorphous | Fe | Si—O | — | — | 80.1 | 19.9 | — | 31.1 | 26.1 | 16.2 |

TABLE 5

| | | Metal Magnetic Particles | | | | | Proportion of Particle Groups | | | | | |
|---|---|---|---|---|---|---|---|---|---|---|---|---|
| | | | | | Second | | | First | Second | Magnetic | | |
| | | | First Small Particles | | Small Particles | | Large | Small | Small | Permeability | | |
| | Ex./ | Large | Particle | | Particle | Film | Particles | Particles | Particles | μi | μHdc | Change |
| Sample | Comp. | Particles | Compo- | Film | Compo- | Compo- | AL/A0 | AS₁/A0 | AS₂/A0 | 0A/ | 8 kA/ | Rate |
| No. | Ex. | Structure | sition | Composition | sition | sition | (%) | (%) | (%) | m | m | (%) |
| B4 | comp. | nanocrystalline | Fe | Ba—Zn—B—Si—Al—O | — | — | 79.7 | 20.3 | — | 30.5 | 24.7 | 19.1 |
| | ex. | | | | | | | | | | | |
| E1 | ex. | nanocrystalline | Fe | Ba—Zn—B—Si—Al—O | Fe | Si—O | 80.2 | 19.7 | 0.1 | 30.5 | 26.1 | 14.4 |
| E2 | ex. | nanocrystalline | Fe | Ba—Zn—B—Si—Al—O | Fe | Si—O | 80.4 | 18.3 | 1.3 | 30.8 | 26.6 | 13.6 |
| B19 | ex. | nanocrystalline | Fe | Ba—Zn—B—Si—Al—O | Fe | Si—O | 80.4 | 9.6 | 10.0 | 31.0 | 26.8 | 13.6 |
| E3 | ex. | nanocrystalline | Fe | Ba—Zn—B—Si—Al—O | Fe | Si—O | 80.5 | 1.0 | 18.5 | 30.6 | 26.4 | 13.7 |
| E4 | ex. | nanocrystalline | Fe | Ba—Zn—B—Si—Al—O | Fe | Si—O | 80.3 | 0.1 | 19.5 | 30.8 | 26.2 | 14.9 |
| B5 | comp. | nanocrystalline | Fe | Si—O | — | — | 79.9 | 20.1 | — | 31.4 | 25.0 | 20.5 |
| | ex | | | | | | | | | | | |

TABLE 6

| | | | | | | | Proportion of Particle Groups | | | | | |
|---|---|---|---|---|---|---|---|---|---|---|---|---|
| | | Metal Magnetic Particles | | | | | | First | Second | Magnetic | | |
| | | | First Small Particles | | Second Small Particles | | Large | Small | Small | Permeability | | |
| Sam- | Ex./ | Large | Particle | | Particle | | Particles | Particles | Particles | μi | μHdc | Change |
| ple | Comp. | Particles | Compo- | Film | Compo- | Film | AL/A0 | AS₁/A0 | AS₂/A0 | 0A/ | 8 kA/ | Rate |
| No. | Ex. | Structure | sition | Composition | sition | Composition | (%) | (%) | (%) | m | m | (%) |
| C4 | comp. | crystalline | Fe | Ba—Zn—B—Si—Al—O | — | — | 80.1 | 19.9 | — | 31.2 | 24.7 | 20.9 |
| | ex. | | | | | | | | | | | |
| F1 | ex. | crystalline | Fe | Ba—Zn—B—Si—Al—O | Fe | Si—O | 79.7 | 19.9 | 0.4 | 31.4 | 26.9 | 14.3 |
| F2 | ex. | crystalline | Fe | Ba—Zn—B—Si—Al—O | Fe | Si—O | 80.0 | 18.3 | 1.7 | 30.8 | 26.4 | 14.3 |
| C19 | ex. | crystalline | Fe | Ba—Zn—B—Si—Al—O | Fe | Si—O | 80.3 | 10.3 | 9.5 | 31.5 | 27.2 | 13.6 |
| F3 | ex. | crystalline | Fe | Ba—Zn—B—Si—Al—O | Fe | Si—O | 80.2 | 1.0 | 18.8 | 30.8 | 27.1 | 12.0 |
| F4 | ex. | crystalline | Fe | Ba—Zn—B—Si—Al—O | Fe | Si—O | 79.9 | 0.1 | 20.0 | 30.9 | 26.6 | 13.9 |
| C5 | comp. | crystalline | Fe | Si—O | — | — | 79.6 | 20.4 | — | 30.9 | 25.4 | 17.9 |
| | ex. | | | | | | | | | | | |

As shown in Table 4 to Table 6, the DC bias characteristics were improved even though the ratios of the small particle groups were changed. It was found that both of AS₁/(AS₁+AS₂) and AS₂/(AS₁+AS₂) were preferably 1% or more and were more preferably 6% or more.

### Experiment 3

In Experiment 3, 18 types of magnetic core samples shown in Table 7 were manufactured by changing the particle compositions of the small particles. In Sample G1 to Sample G4 (Comparative Examples), one type of small particles were employed. In Sample G5 to Sample G10 (Comparative Examples), the first small particles and the second small particles had different particle compositions, but the insulating films having the same composition were formed on the first small particles and the second small particles. On the other hand, in Sample G11 to Sample G18 (Examples), the first small particles and the second small particles had different particle compositions and different film compositions.

In each of Samples of Experiment 3, an amorphous Fe—Co—B—P—Si—Cr based alloy powder was used as the large-diameter powder. Moreover, the Fe—Si based alloy particles (small particles) used in Experiment 3 had an average particle size (arithmetic mean value of Heywood diameters) within the range of 0.5 μm to 1.5 μm, and the Fe—Ni based alloy particles (small particles) used in Experiment 3 had an average particle size within the range of 0.5 μm to 1.5 μm. Moreover, in each of Samples of Experiment 3, the molding pressure during magnetic core production was adjusted so that μi was within the range of 30±2, and that the total area percentage A0 of the metal magnetic particles was within the range of 80±2%.

In Experiment 3, except for changing the particle compositions of small particles, the manufacturing conditions were the same as those of Experiment 1, and the same evaluations as in Experiment 1 were performed. The evaluation results of Experiment 3 are shown in Table 7.

TABLE 7

| | | | | | | | Proportion of | | | | | |
|---|---|---|---|---|---|---|---|---|---|---|---|---|
| | | | | | | | Particle Groups | | | | | |
| | | Metal Magnetic Particles | | | | | | First | Second | | | |
| | | Large | | | | | Large | Small | Small | Magnetic | | |
| | | Parti- | First Small Particles | | Second Small Particles | | Parti- | Parti- | Parti- | Permeability | | |
| Sam- | Ex./ | cles | Particle | | Particle | | cles | cles | cles | μi | μHdc | Change |
| ple | Comp. | Struc- | Compo- | Film | Compo- | Film | AL/A0 | AS₁/A0 | AS₂/A0 | 0A/ | 8 kA/ | Rate |
| No. | Ex. | ture | sition | Composition | sition | Composition | (%) | (%) | (%) | m | m | (%) |
| A4 | comp. | amor- | Fe | Ba—Zn—B—Si—Al—O | — | — | 80.4 | 19.6 | — | 30.6 | 26.5 | 13.5 |
| | ex. | phous | | | | | | | | | | |
| A5 | comp. | amor- | Fe | Si—O | — | — | 80.1 | 19.9 | — | 31.1 | 26.1 | 16.2 |
| | ex. | phous | | | | | | | | | | |
| G1 | comp. | amor- | Fe—Si | Ba—Zn—B—Si—Al—O | — | — | 79.6 | 20.4 | — | 31.1 | 26.2 | 15.7 |
| | ex. | phous | | | | | | | | | | |
| G2 | comp. | amor- | Fe—Si | Si—O | — | — | 80.0 | 20.0 | — | 31.4 | 26.0 | 17.2 |
| | ex. | phous | | | | | | | | | | |
| G3 | comp. | amor- | Fe—Ni | Ba—Zn—B—Si—Al—O | — | — | 80.5 | 19.5 | — | 31.0 | 26.0 | 16.2 |
| | ex. | phous | | | | | | | | | | |
| G4 | comp. | amor- | Fe—Ni | Si—O | — | — | 80.4 | 19.6 | — | 31.4 | 25.9 | 17.5 |
| | ex. | phous | | | | | | | | | | |
| G5 | comp. | amor- | Fe | Ba—Zn—B—Si—Al—O | Fe—Si | Ba—Zn—B—Si—Al—O | 79.9 | 10.3 | 9.8 | 30.8 | 26.4 | 14.2 |
| | ex. | phous | | | | | | | | | | |
| G6 | comp. | amor- | Fe | Ba—Zn—B—Si—Al—O | Fe—Ni | Ba—Zn—B—Si—Al—O | 79.8 | 10.0 | 10.2 | 31.2 | 26.3 | 15.7 |
| | ex. | phous | | | | | | | | | | |
| G7 | comp. | amor- | Fe—Si | Ba—Zn—B—Si—Al—O | Fe—Ni | Ba—Zn—B—Si—Al—O | 79.6 | 9.9 | 10.4 | 31.2 | 25.9 | 16.9 |
| | ex. | phous | | | | | | | | | | |
| G8 | comp. | amor- | Fe | Si—O | Fe—Si | Si—O | 79.9 | 10.0 | 10.1 | 31.2 | 26.4 | 15.4 |
| | ex. | phous | | | | | | | | | | |
| G9 | comp. | amor- | Fe | Si—O | Fe—Ni | Si—O | 79.7 | 9.6 | 10.7 | 31.3 | 26.1 | 16.5 |
| | ex. | phous | | | | | | | | | | |
| G10 | comp. | amor | Fe—Si | Si—O | Fe—Ni | Si—O | 80.2 | 10.4 | 9.4 | 31.4 | 26.0 | 17.1 |
| | ex. | phous | | | | | | | | | | |
| A19 | ex. | amor- | Fe | Ba—Zn—B—Si—Al—O | Fe | Si—O | 80.4 | 9.7 | 9.8 | 30.5 | 28.6 | 6.3 |
| | | phous | | | | | | | | | | |
| G11 | ex. | amor- | Fe—Si | Ba—Zn—B—Si—Al—O | Fe—Si | Si—O | 80.4 | 10.3 | 9.3 | 31.1 | 28.4 | 8.7 |
| | | phous | | | | | | | | | | |
| G12 | ex. | amor- | Fe—Ni | Ba—Zn—B—Si—Al—O | Fe—Ni | Si—O | 80.3 | 10.0 | 9.7 | 30.9 | 27.9 | 9.7 |
| | | phous | | | | | | | | | | |
| G13 | ex. | amor- | Fe | Ba—Zn—B—Si—Al—O | Fe—Si | Si—O | 80.5 | 9.8 | 9.7 | 30.5 | 28.3 | 7.3 |
| | | phous | | | | | | | | | | |
| G14 | ex. | amor- | Fe | Ba—Zn—B—Si—Al—O | Fe—Ni | Si—O | 79.9 | 9.8 | 10.4 | 31.3 | 28.5 | 8.9 |
| | | phous | | | | | | | | | | |
| G15 | ex. | amor- | Fe—Si | Ba—Zn—B—Si—Al—O | Fe | Si—O | 80.1 | 9.8 | 10.1 | 30.5 | 28.3 | 7.3 |
| | | phous | | | | | | | | | | |
| G16 | ex. | amor- | Fe—Si | Ba—Zn—B—Si—Al—O | Fe—Ni | Si—O | 80.0 | 10.2 | 9.7 | 30.7 | 28.3 | 7.9 |
| | | phous | | | | | | | | | | |
| G17 | ex. | amor- | Fe—Ni | Ba—Zn—B—Si—Al—O | Fe | Si—O | 79.6 | 10.5 | 9.9 | 31.4 | 28.8 | 8.3 |
| | | phous | | | | | | | | | | |
| G18 | ex. | amor- | Fe—Ni | Ba—Zn—B—Si—Al—O | Fe—Si | Si—O | 79.6 | 10.4 | 10.0 | 31.0 | 28.1 | 9.3 |
| | | phous | | | | | | | | | | |

As shown in Sample A4, Sample A5, and Samples G1 to G4 in Table 7, in the magnetic cores including one type of small particles, the improvement effect on the DC bias characteristics was not obtained even though the compositions of the small particles were changed. According to the evaluation results of Sample G5 to Sample G10, it was found that when the first small particles and the second small particles include the insulating films with the same composition, the improvement effect on the DC bias characteristics is not obtained even if two types of small particles with different particle compositions are added.

On the other hand, in Sample G11 to Sample G18 (Examples), the change rate in magnetic permeability was less than 10%, and the DC bias characteristics were improved as compared with those of Comparative Examples. From the results of Experiment 3, it was found that the DC bias characteristics are improved by different film compositions of the insulation films between the first small particles and the second small particles, and that the first small particles and the second small particles may have the same particle composition or different particle compositions.

### Experiment 4

In Experiment 4, 15 types of magnetic core samples (Sample H1 to Sample H15) with different proportion between the large particles and the small particles from those in Experiment 1 were manufactured. Table 8 shows the ratios of particle groups in each of Samples of Experiment 4. In Experiment 4, the compounding proportion between the metal magnetic particles and the resin and the molding pressure were adjusted so that the total area percentage AO of the metal magnetic particles in the cross section of the magnetic core was within the range of 80±1%. In each of Samples of Experiment 4, the proportion between the first small particles and the second small particles was set to 1:1. Except for the proportion between the large particles and the small particles, the manufacturing conditions were the same as those in Experiment 1. The evaluation results of Experiment 4 are shown in Table 8.

TABLE 8

| | | | | | | | Total Area | | | | | | |
|---|---|---|---|---|---|---|---|---|---|---|---|---|---|
| | | | | | | | Percentage | Proportion of | | | | | |
| | | | | | | | of | Particle Groups | | | | | |
| | | Metal Magnetic Particles | | | | | Metal | | First | Second | | | |
| | | | First Small Particles | | | | Mag- | Large | Small | Small | | | |
| | | | Parti- | | Second Small | | netic | Parti- | Parti- | Parti- | Magnetic | | |
| | | | cle | | Particles | | Parti- | cles | cles | cles | Permeability | | |
| Sam- | Ex./ | Large | Com- | | Particle | Film | cles | AL/ | AS₁/ | AS₂/ | μi | μHdc | Change |
| ple | Comp. | Particles | po- | Film | Compo- | Compo- | A0 | A0 | A0 | A0 | 0A/ | 8 kA/ | Rate |
| No. | Ex. | Structure | sition | Composition | sition | sition | (%) | (%) | (%) | (%) | m | m | (%) |
| H1 | comp. | amorphous | Fe | Ba—Zn—B—Si—Al—O | — | — | 79.9 | 90.4 | 9.6 | — | 29.4 | 25.8 | 12.2 |
| | ex. | | | | | | | | | | | | |
| H2 | ex. | amorphous | Fe | Ba—Zn—B—Si—Al—O | Fe | Si—O | 80.5 | 90.2 | 5.0 | 4.8 | 29.5 | 27.5 | 6.8 |
| H3 | comp. | amorphous | Fe | Si—O | — | — | 80.5 | 89.7 | 10.3 | — | 29.6 | 25.2 | 14.9 |
| | ex. | | | | | | | | | | | | |
| A4 | comp. | amorphous | Fe | Ba—Zn—B—Si—Al—O | — | — | 79.8 | 80.4 | 19.6 | — | 30.6 | 26.5 | 13.5 |
| | ex. | | | | | | | | | | | | |
| A19 | ex. | amorphous | Fe | Ba—Zn—B—Si—Al—O | Fe | Si—O | 79.7 | 80.4 | 9.7 | 9.8 | 30.5 | 28.6 | 6.3 |
| A5 | comp. | amorphous | Fe | Si—O | — | — | 80.3 | 80.1 | 19.9 | — | 31.1 | 26.1 | 16.2 |
| | ex. | | | | | | | | | | | | |
| H4 | comp. | amorphous | Fe | Ba—Zn—B—Si—Al—O | — | — | 80.2 | 60.0 | 40.0 | — | 28.8 | 25.1 | 12.7 |
| | ex. | | | | | | | | | | | | |
| H5 | ex. | amorphous | Fe | Ba—Zn—B—Si—Al—O | Fe | Si—O | 80.2 | 60.1 | 19.9 | 20.0 | 28.7 | 26.7 | 7.0 |
| H6 | comp. | amorphous | Fe | Si—O | — | — | 79.6 | 60.4 | 39.6 | — | 28.6 | 24.8 | 13.3 |
| | ex. | | | | | | | | | | | | |
| H7 | comp. | amorphous | Fe | Ba—Zn—B—Si—Al—O | — | — | 80.2 | 39.8 | 60.2 | — | 24.6 | 21.9 | 11.0 |
| | ex. | | | | | | | | | | | | |
| H8 | ex. | amorphous | Fe | Ba—Zn—B—Si—Al—O | Fe | Si—O | 80.3 | 39.9 | 30.0 | 30.1 | 24.6 | 22.5 | 8.5 |
| H9 | comp. | amorphous | Fe | Si—O | — | — | 79.8 | 40.3 | 59.7 | — | 24.8 | 21.8 | 12.0 |
| | ex. | | | | | | | | | | | | |
| H10 | comp. | amorphous | Fe | Ba—Zn—B—Si—Al—O | — | — | 80.1 | 20.2 | 79.8 | — | 23.1 | 21.1 | 8.7 |
| | ex. | | | | | | | | | | | | |
| H11 | ex. | amorphous | Fe | Ba—Zn—B—Si—Al—O | Fe | Si—O | 79.8 | 19.5 | 40.5 | 40.0 | 23.2 | 21.9 | 5.6 |
| H12 | comp. | amorphous | Fe | Si—O | — | — | 79.6 | 19.9 | 80.1 | — | 23.1 | 21.1 | 8.7 |
| | ex. | | | | | | | | | | | | |
| H13 | comp. | — | Fe | Ba—Zn—B—Si—Al—O | — | — | 80.0 | 0.0 | 100.0 | — | 22.3 | 20.3 | 9.0 |
| | ex. | | | | | | | | | | | | |
| H14 | comp. | — | Fe | Ba—Zn—B—Si—Al—O | Fe | Si—O | 79.7 | 0.0 | 50.1 | 49.9 | 22.4 | 20.5 | 8.5 |
| | ex. | | | | | | | | | | | | |
| H15 | comp. | — | Fe | Si—O | — | — | 79.7 | 0.0 | 100.0 | — | 22.5 | 20.4 | 9.3 |
| | ex. | | | | | | | | | | | | |

As shown in Table 8, when the total area percentage of the large particles was higher than the total area percentage of the small particles (i.e., when AL>AS was satisfied), the DC bias characteristics were improved with a high magnetic permeability. Moreover, the difference between the change rate in magnetic permeability in Comparative Examples and the change rate in magnetic permeability in Examples was larger in Samples satisfying AL>AS (Sample H2, Sample A19, and Sample H5) than that in Samples satisfying AL≤AS (Sample H8 and Sample H11). That is, when the total area percentage of the large particles was higher than the total area percentage of the small particles, the improvement effect on the DC bias characteristics was further enhanced.

### Experiment 5

In Experiment 5, 24 types of magnetic core samples (Sample I1 to Sample I24) with the total area percentage A0 of metal magnetic particles different from that in Experiment 1 were manufactured. The total area percentage A0 of the metal magnetic particles was controlled by the amount of the epoxy resin (resin amount) with respect to 100 parts by weight of the metal magnetic particles and the molding pressure during magnetic core production. Table 9 and Table 10 show the molding pressure, the resin amount, and the total area percentage A0 of the metal magnetic particles in each of Samples of Experiment 5. Except for the above-mentioned respects, the experimental conditions were the same as those in Experiment 1, and the DC bias characteristics of each of Samples in Experiment 5 were evaluated.

TABLE 9

| | | Metal Magnetic Particles | | | | | Manufacturing | | Total | Proportion of | | | | | |
|---|---|---|---|---|---|---|---|---|---|---|---|---|---|---|---|
| | | | | | Second | | Conditions for | | Area | Particle Groups | | | | | |
| | | | | | Small | | Magnetic | | Percent- | | First | Second | | | |
| | | | | | Particles | | Core | | age of | Large | Small | Small | | | |
| | | Large | First Small Particles | | Parti- | | Mold- | Resin | Metal | Parti- | Parti- | Parti- | Magnetic | | |
| | | Parti- | Parti- | | cle | Film | ing | Amount | Mag- | cles | cles | cles | Permeability | | |
| Sam- | Ex./ | cles | cle | | Com- | Com- | Pres- | (Parts | netic | AL/ | AS₁/ | AS₂/ | μi | μHdc | Change |
| ple | Comp. | Struc- | Compo- | Film | po- | po- | sure | by | Particles | A0 | A0 | A0 | 0A/ | 8 kA/ | Rate |
| No. | Ex. | ture | sition | Composition | sition | sition | (MPa) | Weight) | A0(%) | (%) | (%) | (%) | m | m | (%) |
| I1 | comp. | amor- | Fe | Ba—Zn—B—Si—Al—O | — | — | 392 | 1.0 | 77.1 | 79.5 | 20.5 | — | 28.4 | 25.3 | 11.0 |
| | ex. | phous | | | | | | | | | | | | | |
| I2 | ex | amor- | Fe | Ba—Zn—B—Si—Al—O | Fe | Si—O | 392 | 1.0 | 77.2 | 79.7 | 10.0 | 10.3 | 28.2 | 25.9 | 8.2 |
| | | phous | | | | | | | | | | | | | |
| I3 | comp. | amor- | Fe | Si—O | — | — | 392 | 1.0 | 77.3 | 80.1 | 19.9 | — | 28.3 | 24.9 | 12.1 |
| | ex. | phous | | | | | | | | | | | | | |
| I4 | comp. | amor- | Fe | Ba—Zn—B—Si—Al—O | — | — | 1176 | 1.0 | 85.5 | 80.2 | 19.8 | — | 32.2 | 27.0 | 16.0 |
| | ex. | phous | | | | | | | | | | | | | |
| I5 | ex. | amor- | Fe | Ba—Zn—B—Si—Al—O | Fe | Si—O | 1176 | 1.0 | 85.6 | 79.8 | 10.0 | 10.2 | 32.5 | 29.6 | 8.9 |
| | | phous | | | | | | | | | | | | | |
| I6 | comp. | amor- | Fe | Si—O | — | — | 1176 | 1.0 | 85.4 | 79.8 | 20.2 | — | 32.4 | 26.8 | 17.3 |
| | ex. | phous | | | | | | | | | | | | | |
| A4 | comp. | amor- | Fe | Ba—Zn—B—Si—Al—O | — | — | 392 | 2.5 | 79.8 | 80.4 | 19.6 | — | 30.6 | 26.5 | 13.5 |
| | ex. | phous | | | | | | | | | | | | | |
| A19 | ex. | amor- | Fe | Ba—Zn—B—Si—Al—O | Fe | Si—O | 392 | 2.5 | 79.7 | 80.4 | 9.7 | 9.8 | 30.5 | 28.6 | 6.3 |
| | | phous | | | | | | | | | | | | | |
| A5 | comp. | amor- | Fe | Si—O | — | — | 392 | 2.5 | 80.3 | 80.1 | 19.9 | — | 31.1 | 26.1 | 16.2 |
| | ex. | phous | | | | | | | | | | | | | |
| I7 | comp. | amor- | Fe | Ba—Zn—B—Si—Al—O | — | — | 1176 | 2.5 | 82.5 | 80.3 | 19.7 | — | 34.3 | 28.5 | 17.0 |
| | ex. | phous | | | | | | | | | | | | | |
| I8 | ex. | amor- | Fe | Ba—Zn—B—Si—Al—O | Fe | Si—O | 1176 | 2.5 | 82.4 | 80.3 | 9.8 | 9.9 | 34.3 | 31.4 | 8.5 |
| | | phous | | | | | | | | | | | | | |
| I9 | comp. | amor- | Fe | Si—O | — | — | 1176 | 2.5 | 82.4 | 79.7 | 20.3 | — | 34.6 | 28.3 | 18.3 |
| | ex. | phous | | | | | | | | | | | | | |

TABLE 10

| | | | | | | | | | Total | | | | | | |
|---|---|---|---|---|---|---|---|---|---|---|---|---|---|---|---|
| | | | | | | | | | Area | | | | | | |
| | | | | | | | Manufactur- | | Per- | | | | | | |
| | | | | | | | ing | | cent- | Proportion of | | | | | |
| | | | | | | | Conditions | | age | Particle Groups | | | | | |
| | | | | | | | for | | of | | | Se- | | | |
| | | Metal Magnetic Particles | | | | | Magnetic | | Metal | | First | cond | | | |
| | | | First Small Particles | | Second | | Core | | Magne- | Large | Small | Small | | | |
| | | Large | Parti- | | Small Particles | | Mold- | Resin | tic | Parti- | Parti- | Parti- | Magnetic | | |
| | | Parti- | cle | | Parti- | | ing | Amount | Parti- | cles | cles | cles | Permeability | | |
| Sam- | Ex/ | cles | Com- | | cle | Film | Pres- | (Parts | cles | AL/ | AS₁/ | AS₂/ | μi | μHdc | Change |
| ple | Comp. | Struc- | po- | Film | Compo- | Compo- | sure | by | A0 | A0 | A0 | A0 | 0A/ | 8 kA/ | Rate |
| No. | Ex. | ture | sition | Composition | sition | sition | (MPa) | Weight) | (%) | (%) | (%) | (%) | m | m | (%) |
| I10 | comp. | crystal- | Fe | Ba—Zn—B—Si—Al—O | — | — | 392 | 1.0 | 80.2 | 80.4 | 19.6 | — | 32.3 | 25.7 | 20.4 |
| | ex. | line | | | | | | | | | | | | | |
| I11 | ex. | crystal- | Fe | Ba—Zn—B—Si—Al—O | Fe | Si—O | 392 | 1.0 | 80.3 | 80.2 | 9.5 | 10.2 | 32.4 | 27.8 | 14.3 |
| | | line | | | | | | | | | | | | | |
| I12 | comp. | crystal- | Fe | Si—O | — | — | 392 | 1.0 | 80.2 | 79.6 | 20.4 | — | 32.5 | 26.1 | 19.8 |
| | ex. | line | | | | | | | | | | | | | |
| I13 | comp. | crystal- | Fe | Ba—Zn—B—Si—Al—O | — | — | 1176 | 1.0 | 89.7 | 80.3 | 19.7 | — | 45.0 | 34.9 | 22.5 |
| | ex. | line | | | | | | | | | | | | | |
| I14 | ex. | crystal- | Fe | Ba—Zn—B—Si—Al—O | Fe | Si—O | 1176 | 1.0 | 89.8 | 80.0 | 10.0 | 9.9 | 45.2 | 38.5 | 14.9 |
| | | line | | | | | | | | | | | | | |
| I15 | comp. | crystal- | Fe | Si—O | — | — | 1176 | 1.0 | 89.4 | 80.2 | 19.8 | — | 45.3 | 35.3 | 22.1 |
| | ex. | line | | | | | | | | | | | | | |
| I16 | comp. | crystal- | Fe | Ba—Zn—B—Si—Al—O | — | — | 1568 | 2.5 | 92.2 | 80.4 | 19.6 | — | 47.4 | 36.5 | 23.1 |
| | ex. | line | | | | | | | | | | | | | |
| I17 | comp. | crystal- | Fe | Ba—Zn—B—Si—Al—O | Fe | Si—O | 1568 | 2.5 | 92.1 | 79.8 | 10.4 | 9.8 | 47.8 | 36.9 | 22.9 |
| | ex. | line | | | | | | | | | | | | | |
| I18 | comp. | crystal- | Fe | Si—O | — | — | 1568 | 2.5 | 92.1 | 79.9 | 20.1 | — | 47.9 | 36.7 | 23.3 |
| | ex. | line | | | | | | | | | | | | | |
| I19 | comp. | crystal- | Fe | Ba—Zn—B—Si—Al—O | — | — | 98 | 2.5 | 73.3 | 80.1 | 19.9 | — | 25.6 | 21.6 | 15.5 |
| | ex. | line | | | | | | | | | | | | | |
| I20 | comp. | crystal- | Fe | Ba—Zn—B—Si—Al—O | Fe | Si—O | 98 | 2.5 | 73.2 | 80.1 | 9.6 | 10.3 | 25.8 | 21.9 | 15.3 |
| | ex. | line | | | | | | | | | | | | | |
| I21 | comp. | crystal- | Fe | Si—O | — | — | 98 | 2.5 | 73.1 | 79.8 | 20.2 | — | 25.6 | 21.7 | 15.4 |
| | ex. | line | | | | | | | | | | | | | |
| C4 | comp. | crystal- | Fe | Ba—Zn—B—Si—Al—O | — | — | 392 | 2.5 | 75.4 | 80.1 | 19.9 | — | 31.2 | 24.7 | 20.9 |
| | ex. | line | | | | | | | | | | | | | |
| C19 | ex. | crystal- | Fe | Ba—Zn—B—Si—Al—O | Fe | Si—O | 392 | 2.5 | 75.8 | 80.3 | 10.3 | 9.5 | 31.5 | 27.2 | 13.6 |
| | | line | | | | | | | | | | | | | |
| C5 | comp. | crystal- | Fe | Si—O | — | — | 392 | 2.5 | 75.3 | 79.6 | 20.4 | — | 30.9 | 25.4 | 17.9 |
| | ex. | line | | | | | | | | | | | | | |
| I22 | comp. | crystal- | Fe | Ba—Zn—B—Si—Al—O | — | — | 1176 | 2.5 | 83.4 | 80.3 | 19.7 | — | 34.4 | 27.7 | 19.4 |
| | ex. | line | | | | | | | | | | | | | |
| I23 | ex. | crystal- | Fe | Ba—Zn—B—Si—Al—O | Fe | Si—O | 1176 | 2.5 | 83.2 | 79.6 | 10.0 | 10.4 | 34.3 | 29.4 | 14.3 |
| | | line | | | | | | | | | | | | | |
| I24 | comp. | crystal- | Fe | Si—O | — | — | 1176 | 2.5 | 83.6 | 79.8 | 20.2 | — | 34.4 | 27.9 | 18.9 |
| | ex. | line | | | | | | | | | | | | | |

As shown in Table 9 and Table 10, when the total area percentage A0 of the metal magnetic particles was less than 75% or more than 90%, the improvement effect on the DC bias characteristics was not obtained even though two types of small particles with different film compositions were added. On the other hand, in Examples in which the total area percentage A0 of the metal magnetic particles was 75% or more and 90% or less (Sample I2, Sample I5, Sample A19, Sample I8, Sample I11, Sample I14, Sample C19, and Sample I23), the change rate in magnetic permeability was lower than that in Comparative Examples. From this result, it was found that the improvement effect on the DC bias characteristics is obtained by setting the total area percentage A0 of the metal magnetic particles to 75% or more and 90% or less and dispersing two types of small particles with different film compositions in the magnetic core.

### Experiment 6

In Experiment 6, 12 types of magnetic core samples (Sample J1 to Sample J12) with the average circularities of large particles different from those in Experiment 1 were manufactured. In each of Samples of Experiment 6, the circularities of the large particles were controlled by appropriately adjusting the molten metal temperature, the molten metal injection pressure, the gas pressure, and the gas flow rate during the production of large-diameter powder by quenching gas atomization. Table 11 shows the average circularity of each of Samples measured in a cross section of the magnetic core. Except for the above-mentioned respects, the experimental conditions were the same as those in Experiment 1, and the DC bias characteristics of each of Samples in Experiment 6 were evaluated.

TABLE 11

| | | Metal Magnetic Particles | | | | | | Proportion of | | | | | |
|---|---|---|---|---|---|---|---|---|---|---|---|---|---|
| | | | | | | Second | | Particle Groups | | | | | |
| | | | | First Small Particles | | Small Particles | | Large | First | Second | | | |
| | | | | Parti- | | Parti- | | Parti- | Small | Small | Magnetic | | |
| | | | | cle | | cle | Film | cles | Parti- | Parti- | Permeability | | |
| Sam- | | Large Particles | | Com- | | Com- | Com- | AL/ | cles | cles | μi | μHde | Change |
| ple | Ex./ | | Average | po- | Film | po- | po- | A0 | AS₁/A0 | AS₂/A0 | 0A/ | 8 kA/ | Rate |
| No. | Comp. Ex. | Structure | Circularity | sition | Composition | sition | sition | (%) | (%) | (%) | m | m | (%) |
| J1 | comp. ex. | amorphous | 0.99 | Fe | Ba—Zn—B—Si—Al—O | — | — | 80.4 | 19.6 | — | 30.9 | 26.6 | 14.0 |
| J2 | ex. | amorphous | 0.99 | Fe | Ba—Zn—B—Si—Al—O | Fe | Si—O | 80.1 | 10.0 | 9.9 | 30.9 | 29.1 | 5.9 |
| J3 | comp. ex. | amorphous | 0.99 | Fe | Si—O | — | — | 79.8 | 20.2 | — | 31.0 | 26.3 | 15.0 |
| A4 | comp. ex. | amorphous | 0.97 | Fe | Ba—Zn—B—Si—Al—O | — | — | 80.4 | 19.6 | — | 30.6 | 26.5 | 13.5 |
| A19 | ex. | amorphous | 0.97 | Fe | Ba—Zn—B—Si—Al—O | Fe | Si—O | 80.4 | 9.7 | 9.8 | 30.5 | 28.6 | 6.3 |
| A5 | comp. ex. | amorphous | 0.97 | Fe | Si—O | — | — | 80.1 | 19.9 | — | 31.1 | 26.1 | 16.2 |
| J4 | comp. ex. | amorphous | 0.93 | Fe | Ba—Zn—B—Si—Al—O | — | — | 80.5 | 19.5 | — | 30.6 | 25.9 | 15.4 |
| J5 | ex. | amorphous | 0.93 | Fe | Ba—Zn—B—Si—Al—O | Fe | Si—O | 79.9 | 9.9 | 10.2 | 30.5 | 28.3 | 7.4 |
| J6 | comp. ex. | amorphous | 0.93 | Fe | Si—O | — | — | 79.5 | 20.5 | — | 30.5 | 25.5 | 16.4 |
| J7 | comp. ex. | amorphous | 0.90 | Fe | Ba—Zn—B—Si—Al—O | — | — | 80.0 | 20.0 | — | 30.6 | 26.0 | 15.0 |
| J8 | ex. | amorphous | 0.90 | Fe | Ba—Zn—B—Si—Al—O | Fe | Si—O | 79.5 | 9.7 | 10.8 | 30.1 | 27.7 | 7.8 |
| J9 | comp. ex. | amorphous | 0.90 | Fe | Si—O | — | — | 79.6 | 20.4 | — | 30.6 | 25.9 | 15.4 |
| J10 | comp. ex. | amorphous | 0.87 | Fe | Ba—Zn—B—Si—Al—O | — | — | 79.5 | 20.5 | — | 30.6 | 25.8 | 15.6 |
| J11 | ex. | amorphous | 0.87 | Fe | Ba—Zn—B—Si—Al—O | Fe | Si—O | 80.4 | 10.0 | 9.7 | 30.0 | 27.2 | 9.5 |
| J12 | comp. ex. | amorphous | 0.87 | Fe | Si—O | — | — | 80.3 | 19.7 | — | 30.4 | 25.7 | 15.3 |

As shown in Table 11, the higher the average circularity of the large particles was, the higher the improvement effect on the DC bias characteristics was. The average circularity of the large particles was preferably 0.90 or more and was more preferably 0.95 or more.

### Experiment 7

In Experiment 7, 21 types of magnetic core samples (Sample K1 to Sample K21) were manufactured by changing the average thickness of the insulating films of small particles. The insulating films of the small particles in each of Samples were formed using a powder processing apparatus as shown in FIG. 4, and the average thickness was controlled by adjusting the addition amount of coating materials, the treatment time, and the like. Table 12 shows the average thickness of the insulating films measured in the observation of the cross section of the magnetic core.

In each of Examples of Experiment 7, AL/A0 was within the range of 80±1%, AS₁/A0 was within the range of 10±1%, and AS₂/A0 was within the range of 10±1%. In each of Comparative Examples of Experiment 7, AL/A0 was within the range of 80±1%, and AS/A0 was within the range of 20±1%. Except for the above-mentioned respects, the experimental conditions were the same as those in Experiment 1, and the DC bias characteristics of each of Samples in Experiment 7 were evaluated.

TABLE 12

| | | Metal Magnetic Particles | | | | | | | | | |
|---|---|---|---|---|---|---|---|---|---|---|---|
| | | | | | | Second Small Particles | | | | | |
| | | | | | | | | Average | | | |
| | | | First Small Particles | | | Parti- | | Thick- | | | |
| | | | Parti- | | Average | cle | Film | ness | Magnetic Permeability | | |
| Sam- | | Large | cle | | Thickness | Com- | Com- | of | | | Change |
| ple | Ex./ | Particles | Compo- | Film | of | po- | po- | Films | μi | μHdc | Rate |
| No. | Comp. Ex. | Structure | sition | Composition | Films (nm) | sition | sition | (nm) | 0A/m | 8 kA/m | (%) |
| K1 | comp. ex. | amorphous | Fe | Ba—Zn—B—Si—Al—O | 5 | — | — | — | 31.5 | 27.0 | 14.3 |
| A4 | comp. ex. | amorphous | Fe | Ba—Zn—B—Si—Al—O | 20 | — | — | — | 30.6 | 26.5 | 13.5 |
| K2 | comp. ex. | amorphous | Fe | Ba—Zn—B—Si—Al—O | 50 | — | — | — | 31.1 | 26.8 | 13.6 |
| K3 | comp. ex. | amorphous | Fe | Ba—Zn—B—Si—Al—O | 100 | — | — | — | 31.4 | 27.0 | 13.8 |
| K4 | comp. ex. | amorphous | Fe | Si—O | 5 | — | — | — | 30.8 | 25.4 | 17.5 |
| A5 | comp. ex. | amorphous | Fe | Si—O | 20 | — | — | — | 31.1 | 26.1 | 16.2 |
| K5 | comp. ex. | amorphous | Fe | Si—O | 50 | — | — | — | 30.8 | 25.9 | 16.0 |
| K6 | comp. ex. | amorphous | Fe | Si—O | 100 | — | — | — | 31.1 | 26.2 | 15.8 |
| K7 | ex. | amorphous | Fe | Ba—Zn—B—Si—Al—O | 5 | Fe | Si—O | 5 | 30.6 | 27.6 | 9.8 |
| K8 | ex. | amorphous | Fe | Ba—Zn—B—Si—Al—O | 5 | Fe | Si—O | 20 | 31.4 | 29.0 | 7.6 |
| K9 | ex. | amorphous | Fe | Ba—Zn—B—Si—Al—O | 5 | Fe | Si—O | 50 | 31.3 | 29.2 | 6.8 |
| K10 | ex. | amorphous | Fe | Ba—Zn—B—Si—Al—O | 5 | Fe | Si—O | 100 | 30.7 | 28.7 | 6.6 |
| K11 | ex. | amorphous | Fe | Ba—Zn—B—Si—Al—O | 20 | Fe | Si—O | 5 | 31.4 | 28.7 | 8.5 |
| A19 | ex. | amorphous | Fe | Ba—Zn—B—Si—Al—O | 20 | Fe | Si—O | 20 | 30.5 | 28.6 | 6.3 |
| K12 | ex. | amorphous | Fe | Ba—Zn—B—Si—Al—O | 20 | Fe | Si—O | 50 | 31.3 | 29.3 | 6.2 |
| K13 | ex. | amorphous | Fe | Ba—Zn—B—Si—Al—O | 20 | Fe | Si—O | 100 | 31.4 | 29.5 | 6.1 |
| K14 | ex. | amorphous | Fe | Ba—Zn—B—Si—Al—O | 50 | Fe | Si—C | 5 | 31.3 | 29.2 | 6.8 |
| K15 | ex. | amorphous | Fe | Ba—Zn—B—Si—Al—O | 50 | Fe | Si—O | 20 | 30.9 | 28.9 | 6.5 |
| K16 | ex. | amorphous | Fe | Ba—Zn—B—Si—Al—O | 50 | Fe | Si—O | 50 | 31.2 | 29.2 | 6.5 |
| K17 | ex. | amorphous | Fe | Ba—Zn—B—Si—Al—O | 50 | Fe | Si—O | 100 | 30.9 | 28.9 | 6.3 |
| K18 | ex. | amorphous | Fe | Ba—Zn—B—Si—Al—O | 100 | Fe | Si—O | 5 | 31.4 | 29.4 | 6.6 |
| K19 | ex. | amorphous | Fe | Ba—Zn—B—Si—Al—O | 100 | Fe | Si—O | 20 | 31.3 | 29.3 | 6.5 |
| K20 | ex. | amorphous | Fe | Ba—Zn—B—Si—Al—O | 100 | Fe | Si—O | 50 | 31.4 | 29.3 | 6.6 |
| K21 | ex. | amorphous | Fe | Ba—Zn—B—Si—Al—O | 100 | Fe | Si—O | 100 | 31.4 | 29.4 | 6.4 |

As shown in Table 12, in Comparative Examples (only one type of small particles), the improvement effect on the DC bias characteristics was not obtained even though the insulating films of the small particles were thickened. On the other hand, in each of Examples of Table 12, the DC bias characteristics were improved in all of Examples regardless of the thicknesses of the insulating films, and it was found that the thicknesses of the insulating films are not limited. Moreover, in Examples, the DC bias characteristics tended to be further improved as the insulating films of the small particles were thickened within the range of 100 μm or less.

### Experiment 8

In Sample L1 of Experiment 8, a magnetic core was manufactured using three types of small particles with different film compositions. In Sample L2 of Experiment 8, a magnetic core was manufactured using four types of small particles with different film compositions. The proportion of the first small particles to the third small particles in Sample L1 was 1:1:1, and the proportion of the first small particles to the fourth small particles in Sample L2 was 1:1:1:1. Except for the above-mentioned respects, the manufacturing conditions were the same as those in Sample A19 of Experiment 1, and the DC bias characteristics of Sample L1 and Sample L2 were evaluated. The evaluation results are shown in Table 13.

TABLE 13

| | | Metal Magnetic Particles | | | | | | | | |
|---|---|---|---|---|---|---|---|---|---|---|
| | | | | | Second | | | | | |
| | | | | | Small Particles | | Third Small Particles | | Fourth Small Particles | |
| | Ex./ | Large | First Small Particles | | Particle | Film | Particle | | Particle | |
| Sample | Comp. | Particles | Particle | Film | Com- | Com- | Com- | Film | Com- | Film |
| No. | Ex. | Structure | Composition | Composition | position | position | position | Composition | position | Composition |
| A19 | ex. | amorphous | Fe | Ba—Zn—B—Si—Al—O | Fe | Si—O | — | — | — | — |
| L1 | ex. | amorphous | Fe | Ba—Zn—B—Si—Al—O | Fe | Si—O | Fe | Si—Ba—Mn—O | — | — |
| L2 | ex. | amorphous | Fe | Ba—Zn—B—Si—Al—O | Fe | Si—O | Fe | Si—Ba—Mn—O | Fe | P—Zn—Al—O |
| | | | Proportion of Particle Groups (In Terms of Area Proportion) | | | | | | | |
| | | | Large | First | Second | Third | Fourth | | | |
| | | | Particles | Small | Small | Small | Small | Magnetic Permeability | | |
| | | | AL/A0 | Particles | Particles | Particles | Particles | | | Change |
| Sample | | | (%) | AS₁/A0 | AS₂/A0 | AS₃/A0 | AS₄/A0 | μi | μHdc | Rate |
| No. | | | | (%) | (%) | (%) | (%) | 0A/m | 8 kA/m | (%) |
| A19 | | | 80.4 | 9.8 | 9.7 | | | 30.5 | 28.6 | 6.3 |
| L1 | | | 30.5 | 28.6 | 6.3 | 6.1 | — | 30.6 | 28.6 | 6.4 |
| L2 | | | 80.1 | 7.1 | 6.7 | 4.9 | 5.5 | 30.7 | 28.8 | 6.3 |

As shown in Table 13, similarly to Sample A19, the DC bias characteristics were improved in Sample L1 and Sample L2. From this result, it was found that the number of small particle groups based on the film compositions should be two or more, and the number of small particle groups may be three or four.

### Experiment 9

In Experiment 9, three types of magnetic core samples (Sample M1 to Sample M3) shown in Table 14 were manufactured by adding medium particles in addition to large particles and small particles. Specifically, amorphous Fe—Si—B based alloy particles whose average particle size (arithmetic mean value of Heywood diameters) was 5 μm were added as the medium particles to the magnetic core of Sample M1, crystalline Fe—Si based alloy particles whose average particle size was 5 μm were added as the medium particles to the magnetic core of Sample M2, and nanocrystalline Fe—Si—B—Nb—Cu based alloy particles whose average particle size was 5 μm were added as the medium particles to the magnetic core of Sample M3. Except for the above-mentioned respects, the manufacturing conditions were the same as those in Sample A19 of Experiment 1, and the DC bias characteristics of Sample M1 to Sample M3 were evaluated. The evaluation results are shown in Table 14.

TABLE 14

| | | | | | | | | Proportion of Particle Groups | | | | | | |
|---|---|---|---|---|---|---|---|---|---|---|---|---|---|---|
| | | | | | | | | (In Terms of Area Proportion) | | | | | | |
| | | | | | | | | | Me- | First | Second | | | |
| | | Metal Magnetic Particles | | | | | | Large | dium | Small | Small | | | |
| | | Large | Medium | | | Second | | Parti- | Parti- | Parti- | Parti- | Magnetic | | |
| | | Parti- | Parti | First Small Particles | | Small Particles | | cles | cles | cles | cles | Permeability | | |
| Sam- | Ex./ | cles | cles | Particle | | Particle | Film | AL/ | AM/ | AS₁/ | AS₂/ | μi | μHdc | Change |
| ple | Comp. | Struc- | Struc- | Compo- | Film | Compo- | Compo- | A0 | A0 | A0 | A0 | 0A/ | 8 kA/ | Rate |
| No. | Ex. | ture | ture | sition | Composition | sition | sition | (%) | (%) | (%) | (%) | m | m | (%) |
| M1 | ex. | amor- | amor- | Fe | Ba—Zn—B—Si—Al—O | Fe | Si—O | 70.0 | 10.1 | 9.7 | 10.2 | 30.5 | 28.7 | 5.9 |
| | | phous | phous | | | | | | | | | | | |
| M2 | ex. | amor | crystal- | Fe | Ba—Zn—B—Si—Al—O | Fe | Si—O | 70.0 | 9.9 | 10.2 | 10.0 | 30.5 | 28.4 | 6.9 |
| | | phous | line | | | | | | | | | | | |
| M3 | ex. | amor | nanocrys- | Fe | Ba—Zn—B—Si—Al—O | Fe | Si—O | 69.7 | 9.6 | 9.4 | 11.4 | 30.6 | 28.3 | 7.5 |
| | | phous | talline | | | | | | | | | | | |

As shown in Table 14, in Sample M1 to Sample M3 (the medium particles were further contained in addition to the large particles and the small particles), excellent DC bias characteristics were obtained. From the evaluation results shown in Table 14, it was found that both of the medium particles and the large particles are preferably amorphous from the viewpoint of further improving the DC bias characteristics.

### Experiment 10

In Experiment 10, 38 types of magnetic core samples (Sample N1 to Sample N38) shown in Table 15 to Table 17 were manufactured by changing the compositions of large particles. An insulating film was formed on all of the large particles used in each of Samples in Experiment 10, and the average thickness of the large particles observed in a cross section of the magnetic core was within the range of 15 nm to 25 nm in all of Samples. Except for the above-mentioned respects, the experimental conditions were the same as those in Experiment 1, and the DC bias characteristics of each of Samples in Experiment 10 were evaluated. The evaluation results are shown in Table 15 to Table 17. Among Sample N1 to Sample N38, Samples using one type of small particles were Comparative Examples, and Samples using two types of small particles with different film compositions were Examples.

TABLE 15

| | | | | | | | | Proportion of | | | | | |
|---|---|---|---|---|---|---|---|---|---|---|---|---|---|
| | | | | | | | | Particle Groups | | | | | |
| | | Metal Magnetic Particles | | | | | | | | Se- | | | |
| | | | | | | Second | | | First | cond | | | |
| | | | | First Small Particles | | Small Particles | | Large | Small | Small | | | |
| | | | | Parti- | | Parti- | | Part- | Parti- | Parti- | | | |
| | | | | cle | | cle | Film | icles | cles | cles | Magnetic Permeability | | |
| Sam- | Ex./ | Large Particles | | Com- | | Com- | Com- | AL/ | AS₁/ | AS₂/ | μi | μHdc | Change |
| ple | Comp. | Struc- | Particle | po- | Film | po- | po- | A0 | A0 | A0 | 0A/ | 8 kA/ | Rate |
| No. | Ex. | ture | Composition | sition | Composition | sition | sition | (%) | (%) | (%) | m | m | (%) |
| A4 | comp. | amor- | Fe—Co—B—P—Si—Cr | Fe | Ba—Zn—B—Si—Al—O | — | — | 80.4 | 19.6 | — | 30.6 | 26.5 | 13.5 |
| | ex. | phous | | | | | | | | | | | |
| A19 | ex. | amor- | Fe—Co—B—P—Si—Cr | Fe | Ba—Zn—B—Si—Al—O | Fe | Si—O | 80.4 | 9.7 | 9.8 | 30.5 | 28.6 | 6.3 |
| | | phous | | | | | | | | | | | |
| N1 | comp. | amor- | Fe—Si—B | Fe | Ba—Zn—B—Si—Al—O | — | — | 80.1 | 19.9 | — | 30.2 | 25.9 | 14.4 |
| | ex. | phous | | | | | | | | | | | |
| N2 | ex. | amor- | Fe—Si—B | Fe | Ba—Zn—B—Si—Al—O | Fe | Si—O | 79.7 | 10.3 | 10.0 | 30.3 | 27.3 | 9.8 |
| | | phous | | | | | | | | | | | |
| N3 | comp. | amor- | Fe—Si—B—C | Fe | Ba—Zn—B—Si—Al—O | — | — | 79.6 | 20.4 | — | 29.8 | 25.5 | 14.4 |
| | ex. | phous | | | | | | | | | | | |
| N4 | ex. | amor- | Fe—Si—B—C | Fe | Ba—Zn—B—Si—Al—O | Fe | Si—O | 80.0 | 10.3 | 9.7 | 30.3 | 27.7 | 8.8 |
| | | phous | | | | | | | | | | | |
| N5 | comp. | amor- | Fe—Si—B—C—Cr | Fe | Ba—Zn—B—Si—Al—O | — | — | 79.9 | 20.1 | — | 30.7 | 26.3 | 14.4 |
| | ex. | phous | | | | | | | | | | | |
| N6 | ex. | amor- | Fe—Si—B—C—Cr | Fe | Ba—Zn—B—Si—Al—O | Fe | Si—O | 80.1 | 10.2 | 9.7 | 30.5 | 28.0 | 8.3 |
| | | phous | | | | | | | | | | | |
| N7 | comp. | amor- | Fe—Co—P—C | Fe | Ba—Zn—B—Si—Al—O | — | — | 79.8 | 20.2 | — | 30.2 | 26.1 | 13.3 |
| | ex. | phous | | | | | | | | | | | |
| N8 | ex. | amor- | Fe—Co—P—C | Fe | Ba—Zn—B—Si—Al—O | Fe | Si—O | 79.9 | 10.4 | 9.7 | 30.1 | 27.8 | 7.7 |
| | | phous | | | | | | | | | | | |
| N9 | comp. | amor- | Fe—Co—B | Fe | Ba—Zn—B—Si—Al—O | — | — | 80.0 | 20.0 | — | 30.4 | 26.7 | 12.1 |
| | ex. | phous | | | | | | | | | | | |
| N10 | ex. | amor- | Fe—Co—B | Fe | Ba—Zn—B—Si—Al—O | Fe | Si—O | 79.7 | 10.1 | 10.2 | 30.0 | 27.8 | 7.3 |
| | | phous | | | | | | | | | | | |
| N11 | comp. | amor- | Fe—Co—B—Si | Fe | Ba—Zn—B—Si—Al—O | — | — | 80.4 | 19.6 | — | 30.7 | 27.0 | 12.2 |
| | ex. | phous | | | | | | | | | | | |
| N12 | ex. | amor- | Fe—Co—B—Si | Fe | Ba—Zn—B—Si—Al—O | Fe | Si—O | 80.3 | 10.5 | 9.2 | 30.2 | 27.8 | 7.8 |
| | | phous | | | | | | | | | | | |

TABLE 16

| | | | | | | | | Proportion of | | | | | |
|---|---|---|---|---|---|---|---|---|---|---|---|---|---|
| | | Metal Magnetic Particles | | | | | | Particle Groups | | | | | |
| | | | | | | Second | | | | Se- | | | |
| | | | | | | Small | | | First | cond | | | |
| | | | | First SmallParticles | | Particles | | Large | Small | Small | | | |
| | | | | Parti- | | Parti- | | Parti- | Parti- | Parti- | Magnetic | | |
| | | | | cle | | cle | Film | cles | cles | cles | Permeability | | |
| Sam- | Ex./ | Large Particles | | Com- | | Com- | Com- | AL/ | AS₁/ | AS₂/ | μi | μHdc | Change |
| ple | Comp. | | Particle | po- | Film | po- | po- | A0 | A0 | A0 | 0A/ | 8 kA/ | Rate |
| No. | Ex. | Structure | Composition | sition | Composition | sition | sition | (%) | (%) | (%) | m | m | (%) |
| B4 | comp. | nano- | Fe—Si—B—Nb—Cu | Fe | Ba—Zn—B—Si—Al—O | — | — | 79.7 | 20.3 | — | 30.5 | 24.7 | 19.1 |
| | ex. | crystalline | | | | | | | | | | | |
| B19 | ex. | nano- | Fe—Si—B—Nb—Cu | Fe | Ba—Zn—B—Si—Al—O | Fe | Si—O | 80.4 | 9.6 | 10.0 | 31.0 | 26.8 | 13.6 |
| | | crystalline | | | | | | | | | | | |
| N13 | comp. | nano- | Fe—Si—B—Nb—P | Fe | Ba—Zn—B—Si—Al—O | — | — | 80.0 | 20.0 | — | 30.1 | 24.9 | 17.4 |
| | ex. | crystalline | | | | | | | | | | | |
| N14 | ex. | nano- | Fe—Si—B—Nb—P | Fe | Ba—Zn—B—Si—Al—O | Fe | Si—O | 80.2 | 9.7 | 10.1 | 30.5 | 26.4 | 13.3 |
| | | crystalline | | | | | | | | | | | |
| N15 | comp. | nano- | Fe—Co—B—P—Si | Fe | Ba—Zn—B—Si—Al—O | — | — | 80.0 | 20.0 | — | 30.0 | 25.0 | 16.6 |
| | ex. | crystalline | | | | | | | | | | | |
| N16 | ex. | nano- | Fe—Co—B—P—Si | Fe | Ba—Zn—B—Si—Al—O | Fe | Si—O | 79.9 | 9.6 | 10.5 | 30.4 | 27.0 | 11.1 |
| | | crystalline | | | | | | | | | | | |
| N17 | comp. | nano- | Fe—Co—B—P—Si—Cr | Fe | Ba—Zn—B—Si—Al—O | — | — | 79.9 | 20.1 | — | 29.9 | 25.3 | 15.5 |
| | ex. | crystalline | | | | | | | | | | | |
| N18 | ex. | nano- | Fe—Co—B—P—Si—Cr | Fe | Ba—Zn—B—Si—Al—O | Fe | Si—O | 79.5 | 9.8 | 10.7 | 29.8 | 26.7 | 10.4 |
| | | crystalline | | | | | | | | | | | |

TABLE 17

| | | | | | | | | Proportion of | | | | | |
|---|---|---|---|---|---|---|---|---|---|---|---|---|---|
| | | | | | | | | Particle Groups | | | | | |
| | | | | | | | | | | Se- | | | |
| | | | Metal Magnetic Particles | | | | | | First | cond | | | |
| | | | | First Small Particles | | Second | | Large | Small | Small | | | |
| | | | | Parti- | | Small Particles | | Parti- | Parti- | Parti- | Magnetic | | |
| | | | | cle | | Parti- | Film | cles | cles | cles | Permeability | | |
| Sam- | Ex./ | Large Particles | | Com- | | cle | Com- | AL/ | AS₁/ | AS₂/ | μi | μHdc | Change |
| ple | Comp. | Structure | Particle | posi- | Film | Compo- | posi- | A0 | A0 | A0 | 0A/ | 8 kA/ | Rate |
| No. | Ex. | | Composition | tion | Composition | sition | tion | (%) | (%) | (%) | m | m | (%) |
| C4 | comp. | crystalline | Fe—Si | Fe | Ba—Zn—B—Si—Al—O | — | — | 80.1 | 19.9 | — | 31.2 | 24.7 | 20.9 |
| | ex. | | | | | | | | | | | | |
| C19 | ex. | crystalline | Fe—Si | Fe | Ba—Zn—B—Si—Al—O | Fe | Si—O | 80.3 | 10.3 | 9.5 | 31.5 | 27.2 | 13.6 |
| N19 | comp. | crystalline | Fe | Fe | Ba—Zn—B—Si—Al—O | — | — | 80.5 | 19.5 | — | 29.6 | 23.6 | 20.1 |
| | ex. | | | | | | | | | | | | |
| N20 | ex. | crystalline | Fe | Fe | Ba—Zn—B—Si—Al—O | Fe | Si—O | 79.7 | 10.2 | 10.1 | 29.6 | 25.3 | 14.4 |
| N21 | comp. | crystalline | Fe—Ni | Fe | Ba—Zn—B—Si—Al—O | — | — | 79.6 | 20.4 | — | 30.2 | 23.5 | 22.1 |
| | ex. | | | | | | | | | | | | |
| N22 | ex. | crystalline | Fe—Ni | Fe | Ba—Zn—B—Si—Al—O | Fe | Si—O | 79.6 | 10.1 | 10.3 | 30.4 | 26.1 | 14.3 |
| N23 | comp. | crystalline | Fe—Si—Cr alloy | Fe | Ba—Zn—B—Si—Al—O | — | — | 80.4 | 19.6 | — | 30.0 | 23.9 | 20.3 |
| | ex. | | | | | | | | | | | | |
| N24 | ex. | crystalline | Fe—Si—Cr alloy | Fe | Ba—Zn—B—Si—Al—O | Fe | Si—O | 79.8 | 10.3 | 9.9 | 30.4 | 26.0 | 14.6 |
| N25 | comp. | crystalline | Fe—Si—Al alloy | Fe | Ba—Zn—B—Si—Al—O | — | — | 80.0 | 20.0 | — | 29.8 | 23.8 | 20.1 |
| | ex. | | | | | | | | | | | | |
| N26 | ex. | crystalline | Fe—Si—Al alloy | Fe | Ba—Zn—B—Si—Al—O | Fe | Si—O | 80.5 | 10.4 | 9.1 | 29.9 | 25.6 | 14.3 |
| N27 | comp. | crystalline | Fe—Si—Al—Ni | Fe | Ba—Zn—B—Si—Al—O | — | — | 80.3 | 19.7 | — | 29.8 | 22.9 | 23.1 |
| | ex. | | | | | | | | | | | | |
| N28 | ex. | crystalline | Fe—Si—Al—Ni | Fe | Ba—Zn—B—Si—Al—O | Fe | Si—O | 80.4 | 10.4 | 9.2 | 29.7 | 25.5 | 14.1 |
| N29 | comp. | crystalline | Fe—Ni—Si—Co | Fe | Ba—Zn—B—Si—Al—O | — | — | 79.7 | 20.3 | — | 29.6 | 23.6 | 20.1 |
| | ex. | | | | | | | | | | | | |
| N30 | ex. | crystalline | Fe—Ni—Si—Co | Fe | Ba—Zn—B—Si—Al—O | Fe | Si—O | 79.5 | 10.4 | 10.1 | 30.2 | 26.2 | 13.3 |
| N31 | comp. | crystalline | Fe—Co | Fe | Ba—Zn—B—Si—Al—O | — | — | 79.8 | 20.2 | — | 29.7 | 24.3 | 18.1 |
| | ex. | | | | | | | | | | | | |
| N32 | ex. | crystalline | Fe—Co | Fe | Ba—Zn—B—Si—Al—O | Fe | Si—O | 80.4 | 10.4 | 9.2 | 30.5 | 26.8 | 12.1 |
| N33 | comp. | crystalline | Fe—Co—V | Fe | Ba—Zn—B—Si—Al—O | — | — | 80.0 | 20.0 | — | 30.3 | 25.1 | 17.2 |
| | ex. | | | | | | | | | | | | |
| N34 | ex. | crystalline | Fe—Co—V | Fe | Ba—Zn—B—Si—Al—O | Fe | Si—O | 80.2 | 10.5 | 9.3 | 30.0 | 26.7 | 11.1 |
| N35 | comp. | crystalline | Fe—Co—Si | Fe | Ba—Zn—B—Si—Al—O | — | — | 79.9 | 20.1 | — | 30.0 | 24.8 | 17.4 |
| | ex. | | | | | | | | | | | | |
| N36 | ex. | crystalline | Fe—Co—Si | Fe | Ba—Zn—B—Si—Al—O | Fe | Si—O | 80.5 | 10.2 | 9.3 | 30.1 | 27.0 | 10.1 |
| N37 | comp. | crystalline | Fe—Co—Si—Al | Fe | Ba—Zn—B—Si—Al—O | — | — | 80.1 | 19.9 | — | 29.5 | 24.4 | 17.2 |
| | ex. | | | | | | | | | | | | |
| N38 | ex. | crystalline | Fe-Co-Si-Al | Fe | Ba-Zn-B-Si-Al-O | Fe | Si-O | 79.8 | 9.7 | 10.5 | 30.1 | 27.0 | 10.3 |

As shown in Table 15 to Table 17, comparing Examples and Comparative Examples having the same compositions of large particles, all Examples of Experiment had DC bias characteristics superior to those of Comparative Examples. From the results of Experiment 10, it was confirmed that the compositions of the large particles can be determined freely, and that the DC bias characteristics can be improved by two or more types of small particles with different film compositions.

### DESCRIPTION OF THE REFERENCE NUMERICAL

2 . . . magnetic core
10 . . . metal magnetic particle
10a . . . first particle
11 . . . large particle
4 . . . insulating films of large particles
10b . . . second particle
12 . . . small particle
12a . . . first small particle
12b . . . second small particle
6 . . . insulating films of small particles
6a . . . first insulating film
6b . . . second insulating film
13 . . . medium particle
20 resin
100 . . . magnetic device
5 . . . coil
5a . . . end
5b . . . end
7, 9 . . . external electrode

What is claimed is:

1. A magnetic core comprising metal magnetic particles, wherein
a total area percentage of the metal magnetic particles in a cross section of the magnetic core is 75% or more and 90% or less,
the metal magnetic particles include:
first particles whose Haywood diameters in the cross section of the magnetic core are 3 μm or more; and
second particles whose Haywood diameters in the cross section of the magnetic core are less than 3 μm, and
the second particles comprise two or more types of small particles with different compositions of films existing on their particle surfaces.

2. The magnetic core according to claim 1, wherein A1>A2 is satisfied, in which
A1 is a total area percentage of the first particles in the cross section of the magnetic core, and
A2 is a total area percentage of the second particles in the cross section of the magnetic core.

3. The magnetic core according to claim 1, wherein the first particles comprise large particles having an average circularity of 0.90 or more.

4. A magnetic device comprising the magnetic core according to claim 1.
